(19) United States
(12) Patent Application Publication
(10) Pub. No.: US 2013/0018832 A1
(43) Pub. Date: Jan. 17, 2013

(54) DATA STRUCTURE AND A METHOD FOR USING THE DATA STRUCTURE

(71) Applicants: Kiruthika Ramanathan, Singapore (SG); Sepideh Sadeghi, Singapore (SG)

(72) Inventors: Kiruthika Ramanathan, Singapore (SG); Sepideh Sadeghi, Singapore (SG)

(21) Appl. No.: 13/354,185

(22) Filed: Jan. 19, 2012

(30) Foreign Application Priority Data
Jan. 19, 2011 (SG) 201100418-1

(51) Int. Cl. G06N 3/08

(52) U.S. Cl. 706/25

(57) ABSTRACT

A method is proposed of generating a data structure that comprises a plurality of modules containing neurons. Each module performs a function defined by the neurons. The modules are structured hierarchically in layers, in a bottom-up manner. Competitive ciustering is used to generate the neurons. In the bottom layer, the neurons are associated with data clusters in training data, and in higher layers the neurons are associated with clusters in the output of the next lower layer. Hebbian Association is used to generate “connectivity” data, by which is meant data for pairs of the neurons (in the same layer or in different layer) indicative of the correlation between the output of the pair of neurons.

### FIELD OF THE INVENTION

The invention relates to a data structure, and a method for using the data structure, for example as a classifier. One use of the classifier is for performing text-based information retrieval.

### BACKGROUND OF THE INVENTION

In 1908, the German physician Carl Wernicke formulated the first coherent model for language organization. According to this model, the initial step of information processing occurs in the separate sensory areas of the cortex. The sensory areas of the cortex specialize in auditory or visual information and using Wernicke's model, the image of a cup sends different signals to the visual cortex than that of an image of the word “cup”. Also, hearing the spoken word “cup” generates a series of neuron activations in the auditory cortex and these activations in the auditory cortex are different from those occurring in the visual cortex.

FIG. 18a is a diagram showing the flow of information between parts of the brain. The activations in the visual and auditory cortex are conveyed into an area of the brain that is specialized for processing both visual and auditory information—the angular gyrus. The angular gyrus transforms the spikes into a representation that is shared by both speech and writing i.e. a form of a-modal representation. This a-modal representation is then conveyed to Wemicke's area i.e. the part of the visual cortex that recognizes the information as language and associates the word with a meaning. In Wernicke's area, the word “cup” may be associated with the associated concepts of “drink” or “water”.

The representation of information in Wernicke's area is the common neural representation of language. The common neural representation may be seen as a network of wires connecting concepts in language to their associated meanings. The neural representation is then relayed from Wernicke's area to the Broca's area which is located in another part of the cortex. The information is then transformed from a sensory (a-modal) representation into a motor representation. The motor representation decodes the activation spikes which then lead to the understanding of spoken or written language.

Patterson, K., Nestor, P. and Rogers, T. T. (2007). “Where do you know what you know? The representation of semantic knowledge in the human brain”, Nature Reviews: Neuroscience. 8, 976-987 has proposed that the Anterior Temporal lobe in the cortex is responsible for acting as a hub that performs semantic associations. FIG. 18b shows the integration in the brain of information from multiple inputs.

It has been suggested that information entering the brain is associated together in an “association area” that is different from the sensory area. Rogers T T and McClelland J L (2003), “The parallel distributed processing approach to semantic cognition”, Nature Reviews Neuroscience, 4(4), pp 310-322 disclosed modeling the association area as an artificial neural network (ANN) with the parallel distributed processing (PDP) model and trained the ANN using a back-propagation algorithm. It is then disclosed that the PDP model for semantic cognition properties of semantic memory such as learning ability and semantic dementia. FIG. 18c shows the ANN that is used in Rogers T T and McClelland J L (2008).

### SUMMARY OF THE INVENTION

The present invention aims to provide a new and useful data structure, and a method for using the data structure, such as for performing text-based information retrieval.

In general terms, the invention proposes a method of generating a data structure that comprises a plurality of modules containing neurons. Each module performs a function defined by the neurons. The modules are structured hierarchically in layers (also called “levels”), in a bottom-up manner. Competitive clustering is used to generate the neurons. In the bottom layer, the neurons are associated with data clusters in training data, and in higher layers the neurons are associated with clusters in the output of the next lower layer. Hebbian Association is used to generate “connectivity” data, by which is meant data for pairs of the neurons (in the same layer or in different layers) indicative of the correlation between the output of the pair of neurons.

This connectivity data may be used in several ways. First, it may be used to analyze the data structure, for example so as to assign meaning to the modules, or to identify “associated” neurons or modules. Second, it may be used during the generation of the data structure, by influencing the way in which neurons in a given layer are grouped, such that a given group of neurons (each group having one or more neurons, and typically a plurality of neurons which are typically not all from the same module) all pass their outputs to a corresponding module of the next layer. Thirdly, it may be used to modify the data structure, for example in a process of simplifying the data structure by removing connections.

Specifically, a first expression of the invention is a method for generating a data structure comprising a plurality of layers (r=1, . . . , L) ordered from a lowest layer (r=1) to a highest layer (r=L), each layer including one or more modules, the modules being ordered in a bottom-up hierarchy from the lowest layer to the highest layer, each of the plurality of modules being defined by one or more neurons configured to produce output signals in response to one or more inputs to the module, the method employing a plurality of training data samples, each data sample being a set of feature values;
the method comprising:
(i) generating a lowest layer (r=1), wherein, for each module of the first layer, one or more neurons of the module are generated associated with one or more respective data clusters in the respective feature value, and
(ii) generating one or more higher layers of the data structure (r=2, . . . L) by, for the r-th higher layer, generating modules of the r-th layer which receive as inputs the output signals of a corresponding group of a plurality neurons of the (r−1)-th layer, and performing competitive clustering, whereby, for each module of the r-th layer, one or more neurons of the module are generated associated with a respective data cluster in the inputs to the module; and
(iii) performing a Hebbian algorithm to obtain, for each of a plurality of pairs of the neurons, a corresponding plurality of synaptic weights, each synaptic weight being indicative of the correlation between the output signals of the corresponding pair of neurons.

Certain embodiments of the present invention may have the advantages of:
producing a data structure that can mimic the human brain in performing semantic association;
being usable as a mechanism for representing information;
being usable as an associative mechanism for associating a piece of information with one or more other pieces of associated information;
being usable as a mechanism for retrieving information that is trained into the data structure;
being usable as a means for performing dimension reduction to data;
being usable for diverse applications in diverse fields, for example for information retrieval, neuromorphic engineering, robotics, electronic memory systems, data mining, information searching and image processing;
being robust to the degradation of memory;
being capable of performing word association or gist extraction; and
being capable of classifying information according to multiple similarities between input features.

### BRIEF DESCRIPTION OF THE FIGURES

By way of example only, an embodiment will be described with reference to the accompanying drawings, in which:

FIG. 1 is a flow-chart of a system for machine learning and classification according to an example embodiment;

FIG. 2a is a schematic drawing of a data structure of the system of FIG. 1 in relation to the environment;

FIG. 2b is a schematic drawing of the data structure of FIG. 2a showing a plurality of modules in the data structure;

FIG. 2c is a flow-chart of a method for training the data structure of FIG. 2b;

FIG. 2d is a schematic drawing showing the connections between modules of different layers of the data structure created by the method of FIG. 2c;

FIG. 2e is a schematic drawing showing two groups of neurons formed by graph partitioning in one form of an integration step of the method of FIG. 2c;

FIG. 2f is a schematic drawing of a method for performing automatic integration by the graph partitioning of FIG. 2e;

FIG. 2g is a schematic drawing showing a matrix containing part of the data set that is used in “Semantic Cognition: A Parallel Distributed Processing approach”, by Timothy T Rogers and James McClelland, Bradford Books, 2004;

FIG. 2h is a flow chart of a method for using the data structure of FIG. 2b;

FIG. 2i is a schematic drawing of a generalized form of data structure of FIG. 2b which can be used by the method of FIG. 2h;

FIG. 3 is a drawing showing a plurality of synaptic weights corresponding to the synaptic connections between each pair of neurons in a bottom layer of a data structure produced by the method of FIG. 2c;

FIG. 4a is a graph showing the two-dimensional principal components for a Module 2 of a second layer of the data structure of FIG. 3;

FIG. 4b is a graph showing the two-dimensional principal components for Modules 4, 5, 7, 8, 9, 12, 13 and 14 of the second layer of the data structure of FIG. 3;

FIG. 4c illustrates synaptic connection weights between pairs of layer 2 neurons second layer of the data structure of FIG. 3;

FIG. 4d illustrates synaptic connection weights between pairs of neurons in layers 1 and 2 of the data structure of FIG. 3;

FIGS. 5a, 5b and 5c are graphs showing the principle components for a respective Module 1, Module 2 and Module 3 of a third layer of the data structure of FIG. 3;

FIG. 5d is a drawing showing a plurality of synaptic weights corresponding to the synaptic connections between each pair of a plurality of neurons of the data structure of FIG. 3;

FIG. 5e is a drawing showing the sparse connection weights between the 33 neurons of the third layer of the data structure of FIG. 3 and the 30 neurons of a fourth layer of the data structure of FIG. 3;

FIG. 6 is a drawing showing the sparse connection weights between the 33 neurons of the another ANN of FIG. 5e and the 20 neurons of yet another ANN of a fifth layer of the data structure of FIG. 3;

FIGS. 7a, 7b, 7c, 7d and 7e are histograms showing the distribution of synaptic weights between any two neurons of the ANN of FIG. 3, wherein the τ value respectively are 0, 0.2, 0.5, 0.65, 0.8 and 0.9;

FIG. 8 is a drawing showing the probability that an input feature associated with a property triggers one or more neurons of the ANN of FIG. 3, wherein the one or more neurons is associated with a corresponding one or more topics;

FIG. 9a is a drawing of a synaptic pathway in the data structure of FIG. 3, the synaptic pathway associating a property {CanSing} with a topic “canary”;

FIG. 9b is a drawing of another synaptic pathway in the data structure of FIG. 3 associating another property {CanFly} with the topics “robin”, “sparrow” and “canary”;

FIG. 10 is a drawing showing a plurality of synaptic weights associating properties and topics across the hierarchy of the data structure of FIG. 3;

FIG. 11 is a graph showing the activation of the concepts {Canary, CanSing}, {Canary, CanFly}, {Canary, IsAnimal} and {canary, CanGrow} in the data structure of FIG. 3;

FIG. 12a is a flow-chart of a method of training a data structure for performing text-based information retrieval according to a third example embodiment;

FIG. 12b is a structure incorporating the data structure produced by the method of FIG. 12a, but with an additional network generated by supervised learning.

FIG. 12c is a flow-chart of a method of performing text-based information retrieval using the data structure of FIG. 12a;

FIG. 13 is a drawing showing the labels of the top 8 neurons obtained by training the data structure of FIG. 12a with the 20 newsgroup corpus;

FIG. 14 is a chart showing the average association precision for the data structure of trained with the corpus of FIG. 13;

FIGS. 15a, 15b, 15c, 15d, 15e and 15f show the correlation coefficients of 30 randomly selected documents respectively: (a) when the data structure is trained using the method of FIG. 12a, (b) when an all words method is used in computing the correlation, (c) when Principal Component Analysis (PCA) is used to perform dimensionality reduction on the documents, (d) when the K-means algorithm is used to perform dimensionality reduction on the documents, (e) when a Fuzzy c-means based algorithm is used to perform dimensionality reduction on the documents, and (f) when a Self-Organizing Map (SCM) is used to perform dimensionality reduction on the documents;

FIG. 16a is a chart showing the neural activation over the top 20 neurons of the data structure of FIG. 15a;

FIG. 16b is a screenshot showing the information retrieval results from the Google search engine when the query terms used are a keyword “diamond” and the relevant terms of the keyword;

FIG. 16c is a screenshot showing the information retrieval results from the Google search engine when the query terms used are the keyword of FIG. 16b, and the associated terms and relevant terms of the keyword;

FIG. 17 is a drawing showing the labels of the top 50 neurons obtained by training the data structure of FIG. 12a with a NSF research awards database;

FIG. 18a is a schematic drawing of the prior art showing the flow of information between parts of the brain;

FIG. 18b is a schematic drawing of the prior art showing the integration of information from multiple inputs in the brain; and

FIG. 18c is a schematic drawing showing an ANN of the prior art.

### DETAILED DESCRIPTION OF THE PREFERRED EMBODIMENT

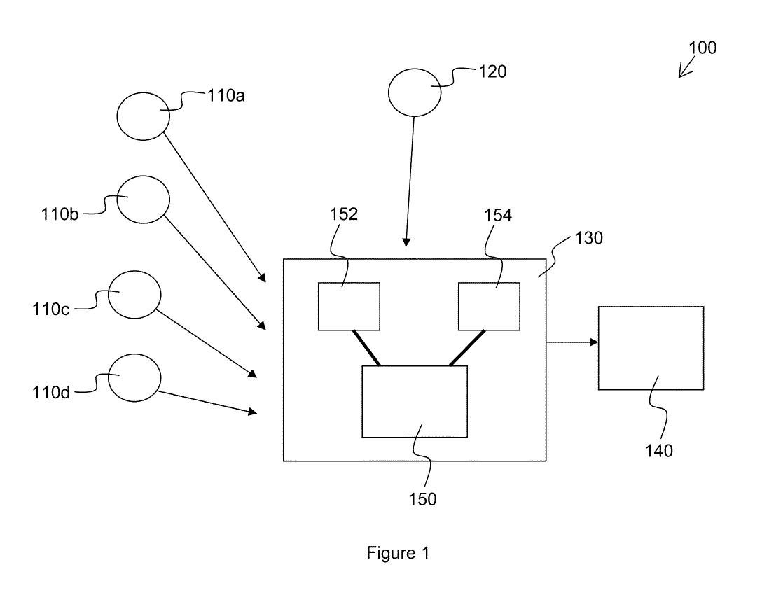

FIG. 1 shows a system 100 for machine learning and classification. The system 100 comprises a plurality of input devices 110a-110d and 120, a computer 130, and an output device 140. The computer 130 contains training software 152 which is configured to train a data structure 150 that is hosted on the computer 130. Once trained, the computer 130 also contains classification software 154 which executes the data structure 150 so that it may be used to perform a variety of data classification tasks.

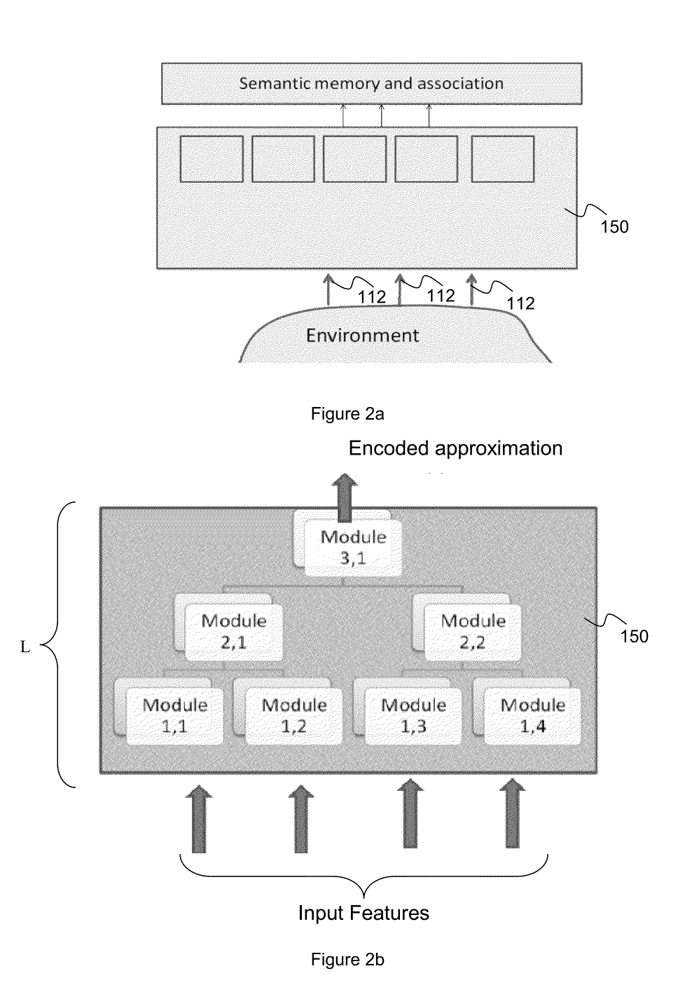

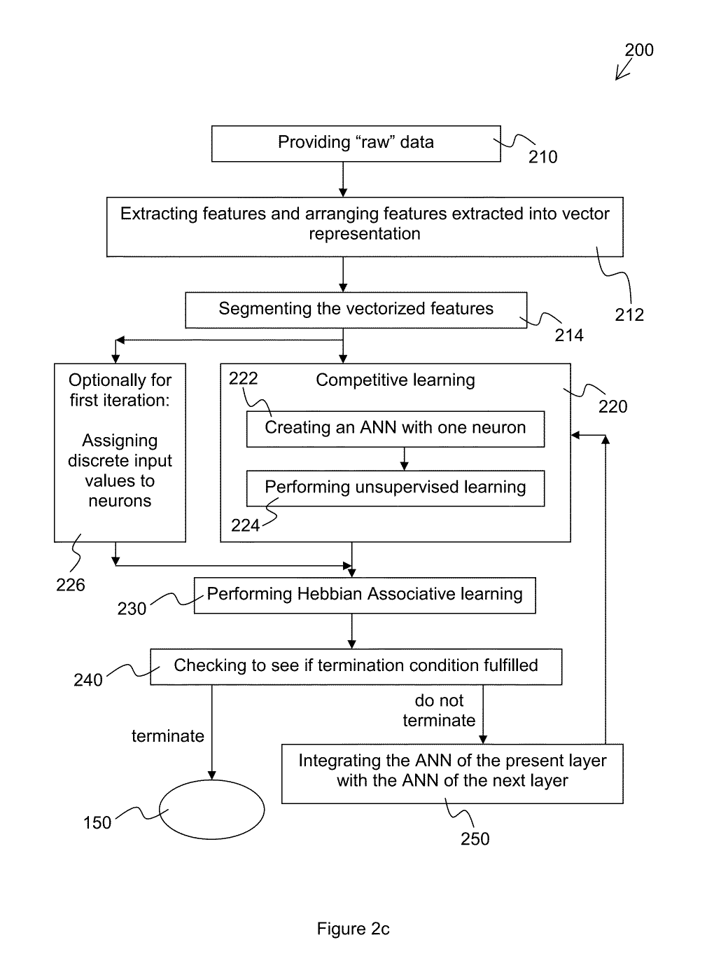

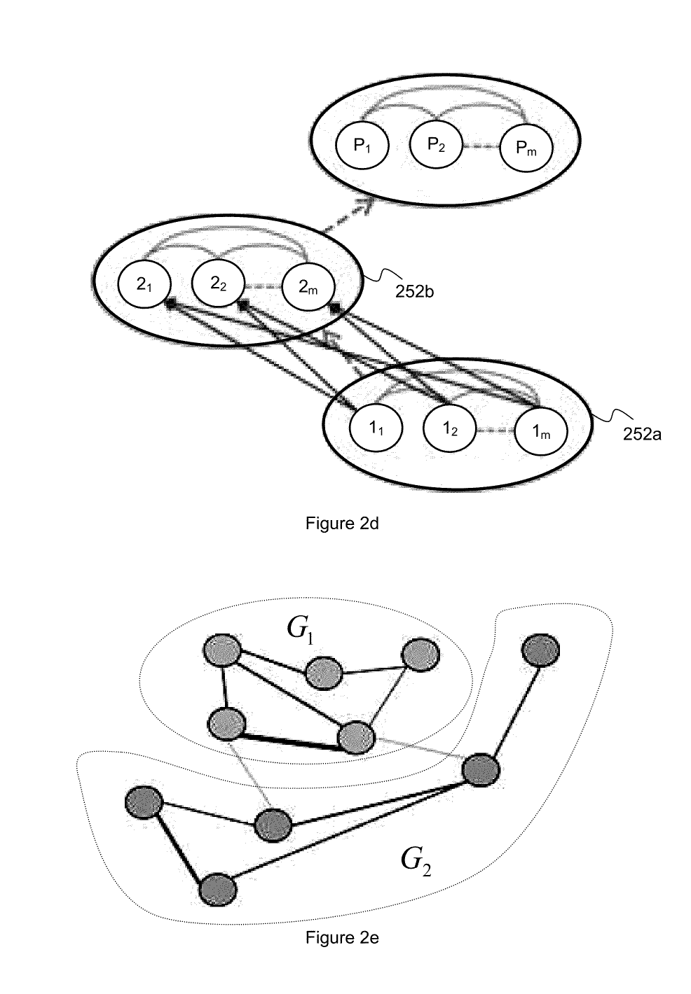

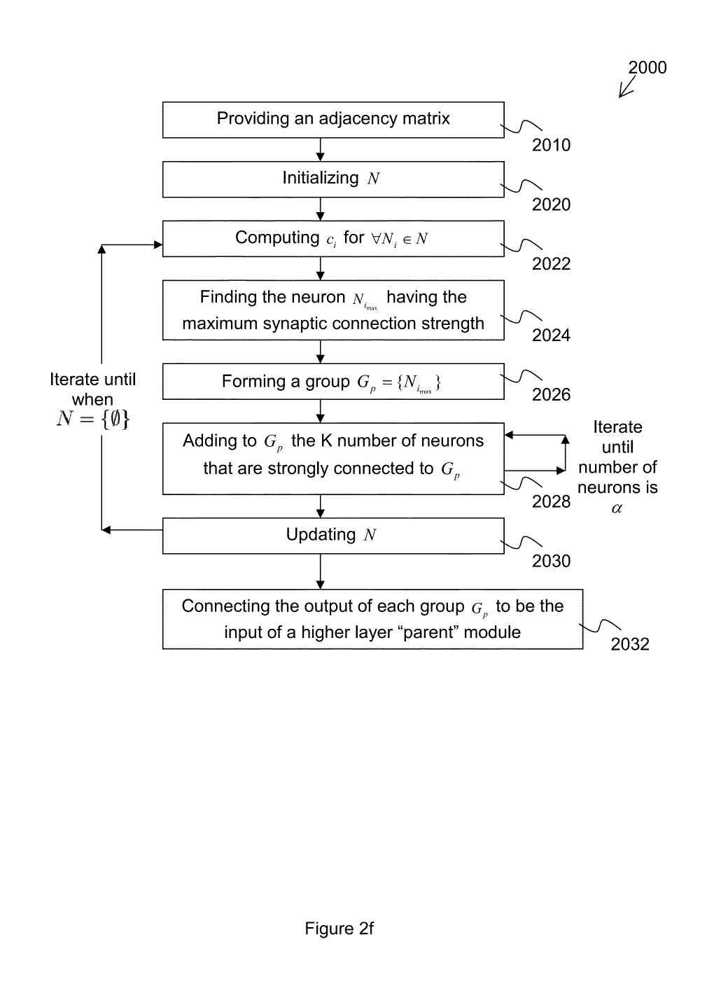

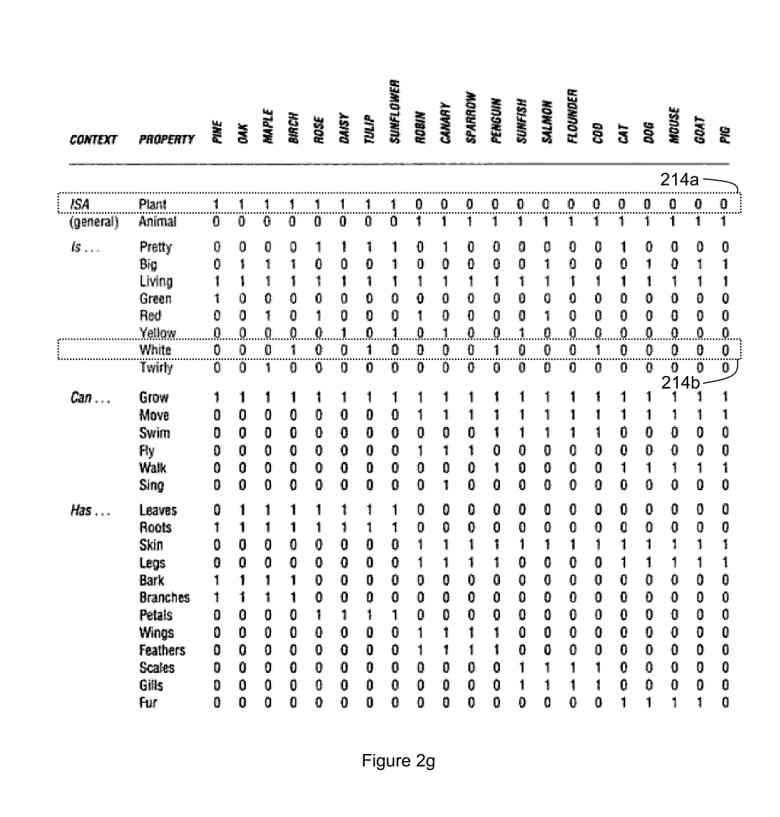

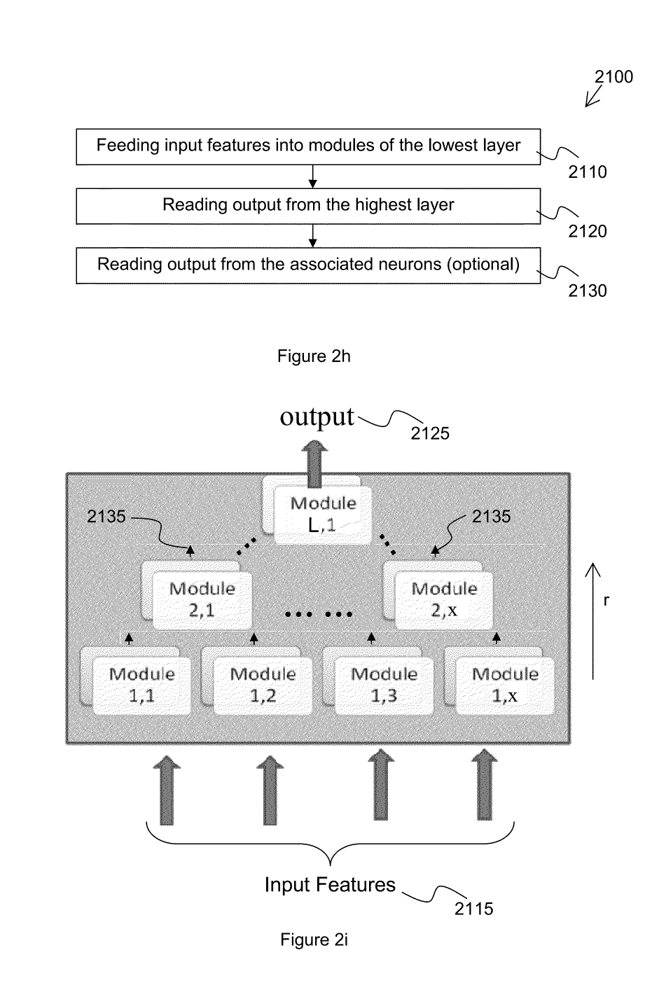

During training, the input devices 110a-110d provide “raw” data for training the data structure 150. The input devices 110a-11d may for example be storage devices e.g. hard disks, network devices e.g. network interfaces, or data sensors e.g. cameras or microphones. The data is fed into the computer 130 and the training software 152 then uses the data to train the data structure 150 according to the method 200 that is shown in FIG. 2c.

Once the data structure 150 is trained, the data structure 150 is then usable, for example for performing classification. When performing classification, another input device 120 provides the data sample that is to be classified. Like the input devices 110a-11d, the input device 120 may for example be a storage device, a network device or a data sensor. The data sample is fed into the computer 150 and the classification software 154 then executes the data structure 150 to output a decision based on the data sample. This decision is sent from the computer 130 to the output device 140. The output device 140 may for example be another storage device e.g. a hard disk, or a control system for an actuator e.g. a motor driver, or a display device e.g. a display screen, or a speaker that is capable of reading out the decision of the data structure 150. In the case where the output device 140 is a display screen, the decision is displayed on the screen for viewing by a user.

Where the input devices 110a-11d and/or 120 are data sensors, these devices convert environmental information into digital signals. Examples of data sensors are camera, microphones or temperature sensors and in these examples, the environmental information respectively are images, audio waves, or temperature readings. Quantization is performed on the environmental information gathered by the data sensor in order to convert them into digital form. By quantization, the environmental information of the preceding examples may be respectively converted into image pixels values, audio features, or numbers representative of temperature readings. It is envisaged that quantization may be performed on-board in the data sensors 110a-110d and/or 120, or may be performed in the computer 130.

Additionally, it is envisaged that the input devices 110a-110d and 120 may be suitable for receiving textual data e.g. a keyboard, or a network connection providing a text feed, or a text file that is read off a storage device. In such a case, the digital feature that is usable as training data may be a series of words.

Further, it is envisaged that the computer 130 may take the form of a plurality of computers. In this case, the data structure 150 exists across the plurality of computers.

### The Data Structure

FIG. 2a is a diagram illustrating the data structure 150 in relation to the environment. It can be seen that the data structure 150 takes as input features derived from environmental sensory stimuli 112. The sensory stimuli 112 may be multimodal and multisensory in that they may be a combination of for example, visual or auditory features, or words read from a text, or a set of somatic sensory inputs. The multimodal stimuli 112 are converted to features which are mode insensitive i.e. the sensory mode of the stimuli 112 would be of no consequence. The data structure 150 has semantic properties are thus usable to perform associations between these features, or between the features and certain topics.

FIG. 2b is a diagram showing the modules of the data structure 150. The data structure 150 has a Hubel-Weisel (HW) structure where the data structure 150 comprises a plurality of layers that are structured hierarchically in a bottom-up manner. The data structure 150 is a type of deep belief network where the plurality of layers are trained layer by layer from the bottom-up. Each layer of the plurality of layers in turn comprises one or more modules. As an example, in FIG. 2b, the lowest layer of the hierarchy is occupied by Modules 1.1, 1.2, 1.3 and 1.4. The next highest layer is then occupied by Modules 2.1 and 2.2. FIG. 2i shows a generalized form of the data structure of FIG. 2b, in which the number of layers is L and the number of modules at each layer below the top layer is x. An index r (1, . . . , L) labels the layers. The modules of each layer may be labeled M_{r,m} where m is an index running from 1 up to the number of modules in the r-th layer.

The HW structure of the data structure 150 allows it to deconstruct input features into modular features. These modular features are then reassembled in the subsequent layers to form a decision based on the input features. The module at the top most layer of the data structure 150 performs pattern recognition. At the lower layers, modules in these layers are responsible for recognizing features or combination of features.

Each module receives one or more inputs. Each module has a function defined by (“contains”) a plurality of neurons. Each neuron is defined using a weight vector having a number of components equal to the number of inputs to the module. Note that the number of inputs to the module may just be one, in which case the weight vector for each neuron is just a scalar (i.e. an integer or a real number). The module has one output for each respective neuron it contains.

The output function may be defined in several ways, but generally it includes a linear operation of multiplying the components of the weight vectors with the respective inputs to produce products, followed by a non-linear operation performed on the products, to generate an activation value for each neuron which is the output of the neuron. For example, the output of a given neuron in response to an input may be 1 if the Euclidean distance between its weight vector and the input is least compared with the other neurons in the module, and otherwise zero (“winner takes all”). Alternatively, the output of each neuron may be a non-linear function (e.g. a Gaussian function) of a dot product between the corresponding weight vector and the input. In another possibility (which combines the two above possibilities), the output of each neuron may be a non-linear function of a dot product between the corresponding weight vector and the input if that dot product is a maximum compared with the other neurons of the module, and otherwise zero.

The process of forming connections between layers of the neural network is called “integration”. If the outputs of a given set of two (or more) modules are the inputs to a module of the next higher layer, the outputs of the set of modules are “concatenated”. That is, the inputs of the module of the next higher layer are respective outputs of the set of modules. For example, if the set of modules is just two modules, one with four outputs and one with five outputs, then the module of the next higher layer receives nine inputs: four from the first module of the set and five from the second module of the set.

FIG. 2d shows an example of integration between modules 252a and 252b of different, consecutive layers of the data structure 150. In FIG. 2d, the neurons of the first module 252a are labeled 1₁, 1₂, 1₃, . . . 1ₘ. The neurons of the module 252b are labeled 2₁, 2₂, 2₃, . . . 2ₘ. Dashed arrow lines indicate feed-forward connection paths between modules. Since the module 252a feeds the module 252b, the module 252a is a “child” module of the “parent” module 252b. Bold arrow lines indicate synaptic connections between the m neurons of the module 252a to the neurons of the module 252b. The lines of the figure between neurons of the same layer represent measured synaptic weight values obtained during the Hebbian associative learning step 230.

Whilst the term “data structure” is used to refer to the data structure 150, the data structure 150 has classification and machine learning capabilities. It is capable of performing classification and may also be used as an abstract data-type for representing information, or as an associative mechanism for associating a piece of information with one or more other pieces of associated information, or as a mechanism for retrieving information that is trained into the data structure 150, or as a means for performing dimension reduction to data.

### Method of Training the Data Structure

Turning to FIG. 2c, FIG. 2c shows a method 200 for training the data structure 150. In step 210, the input devices 110a-110d provide “raw” data usable for training the data structure 150. In the case where the input devices 110a-11d are storage devices or network devices, data is read or received from the input devices 110a-11d and then provided to the computer 130 as the “raw” training data.

In the case where the input devices 110a-110d are data sensors, the input devices 110a-11d capture information about its physical environment e.g. the input devices 110a-11d capture images, or audio recordings, and quantization is then performed in order to convert the captured information into digital signals. The digital signals are then provided to the computer 130 as the “raw” training data.

Also, should the input devices 110a-110d be suitable for receiving textual data, the input devices 110a-110d obtains the textual data e.g. by reading a text document off a storage device, or by receiving a typed input from a user. The textual data is then passed to the computer 130 as the “raw” training data.

In step 212, feature extraction is performed on the “raw” training data and the resultant features are then arranged into vector representations. In the case where the “raw” data is a digitized image, a bank of Gabor filters may be applied to the digitized image to yield a plurality of Gabor filter features. The features resulting from the filter bank are then arranged into a single feature vector. Alternatively, a collection of visual words or edge detection features may be extracted from the digitized image and the features for each image is then formed into a single feature vector.

In the case where the “raw” data is textual data, the “raw” data is converted into a collection of term frequency-inverse document frequency (td-idf) weights, or a bag of words representation. In these cases, each element in the vector representation of the textual data is indicative of the occurrence or occurrence frequency of a term.

Further, feature extraction may be performed by applying a classifier to the “raw” training data. As an example, a classifier of the Rubel-Weisel architecture may be applied to a digitized image to obtain a set of features. The set of features for each image is then arranged into a vector representation.

In step 214, segmentation is performed on the vectorized representation of the “raw” training data. The step of segmentation may be seen to be analogous to how sensory stimuli incoming to a brain are divided to be processed depending on the originating sensory organs. It is responsible for organizing the elements of the vectorized training data and associating the elements with corresponding modules of the lowest layer of the data classifier which will be generated during the remaining steps of the method of FIG. 2c.

As example, reference is made to FIG. 2g where a matrix is shown containing part of the data set that is used in “Semantic Cognition: A Parallel Distributed Processing approach”, by Timothy T Rogers and James McClelland, Bradford Books, 2004. This dataset displays 28 features (from {IsAPlant} to {HasFur}.

There are 21 data samples in the matrix running from the left most “PINE” to the right most “PIG”. Each column of the matrix contains the feature elements of a data sample and each feature element is a Boolean representation of a property associated with data sample. Thus, the row 214a shows the realizations of the feature {IsAPlant} for each of the 21 data samples, while the row 214b shows the realization of the feature {IsWhite} for each of the 21 data samples.

In the remaining steps of FIG. 2c, the data structure is generated. The number of modules in the lower layer (i.e. the input layer) is equal to the number of features. The feature segments are used as the inputs for the respective modules. Thus in the example of learning the data of FIG. 2d, the input layer which will be generated by the method of FIG. 2c will have 28 modules, corresponding to the 28 features.

Returning to FIG. 2c, step 220 is responsible for the creation of modules in a given layer of the data structure. The first time step 220 is performed, it generates the modules of the lowest layer (i.e. the input layer) of the data structure. Whenever step 220 is performed, the neurons it creates in a given module have a number of weights which is equal to the dimensionality of the respective feature. Since, in the example of learning the data of FIG. 2d, each feature is represented by a single number (i.e. a Boolean value +1 or −1), the input to the modules of the lowest layer is this number, so each neuron of modules in the lowest layer has only a single weight value.

In step 220, competitive learning is performed to identify data clusters in the input to the modules. Following competitive learning, each data cluster in the input to a given module is represented by one neuron of the resulting module. Since, in the example of learning the data of FIG. 2d, each feature can only take one of two Boolean values (+1 or −1), the competitive learning will generate (at least) two neurons in each module: a neuron which fires (i.e. wins the winner-takes-all operation) when the input is +1, and a neuron which fires when the input is −1.

Step 220 comprises the sub-steps 222 and 224. In sub-step 222, each of the modules of the layer is initialized, as an ANN with a single neuron N₁.

Sub-step 224 includes (when generating the first layer) presenting data samples (i.e. in the case of learning the matrix of FIG. 2d, columns of that matrix) in a random order to the modules of the layer, and in each module performing unsupervised learning.

### Sub-Step 222:

Create an ANN with one neuron N₁. Let index j denote the inputs to a given module (e.g. if there is only one input for a given module, j takes only one possible value). Thus, N₁ is a vector with components w_{i,j}. These may be assigned a random weight value, or may be assigned a predetermined value.

### Sub-Step 224:

Denote the set of data samples to be learnt as X which is composed of many data samples Xₖ, ∀XₖεX. Each of the examples Xₖ has a number of components equal to the number of components of N₁. For successive ones of the data samples (in a random order),
if ∀NᵢεN, ∥Xₖ−Nᵢ∥>τ,
   add a new neuron with a neuron value representing the value of Xₖ,
else
   find the value of Nᵢ which has the minimum value of ∥Xₖ−Nᵢ∥; and
   update weight w_{i,j} of Nᵢ using the competitive learning

Equation 1:

w_{i,j}(t)=w_{i,j}(t−1)+η(Xₖ−w_{i,j}(t−1)) (1)

N denotes the set of all neurons in the module, τ is a growth threshold value,
η represents a training factor, τ denotes the training epoch.

It is envisaged that instead of performing the sub-steps 222 and 224, other forms of competitive learning may be performed in step 220. For example, the input features may be clustered using a Self Organizing Map (SOM), a Self-Growing Network, or the HMAX or Hierarchical Temporal Memory (HTM) algorithms may be used.

Step 220 is carried out until a termination criterion is reached (e.g. a stagnation criterion: the weight vectors change by less than a pre-defined value).

In the case where the data samples for step 220 are discrete e.g. where each feature is represented by a Boolean value, competitive learning optionally may be omitted, and replaced by a step of constructing the bottom-layer modules. In this case, step 226 is performed where each discrete input value for each feature is assigned to an input neuron at the lowest layer. The neurons corresponding to the discrete input values for a feature then collectively form a module. An input of a value for a feature is then represented by triggering the corresponding neuron. As an example, where an input feature is Boolean, that input feature may be represented using a first neuron and a second neuron. These neurons respectively correspond to the input values +1 and −1. A triggering of the first neuron represents an input of +1 and at trigger of the second neuron then represents an input of −1.

In 230 there is an operation of analysing the network formed thus far. In step 230, Hebbian associative learning is performed upon the ANN resulting from step 220. Hebbian associative learning is performed in order to derive the co-occurrence frequency between associated neurons. Specifically, a “synaptic weight” value (also sometimes called here a “synaptic strength” value) \tilde{w}_{i,j} is defined for each pair of neurons i and j. In step 230, each of the data samples is presented to the input layer in a random order, and it is determined which neurons fire (that is, which neurons win the “winner takes all” procedure). A Hebbian association operator given by Equation 2 is used to modify the synaptic weight of pairs of neurons. Given the pre-synaptic neuron i and post-synaptic neuron j, with their respective activations being denoted φ(i) and φ(j):

$$\{ \begin{matrix}{\tilde{w}}_{i , j} ( t ) = {\tilde{w}}_{i , j} ( t - 1 ) + η ( 1 - {\tilde{w}}_{i , j} ( t - 1 ) ) & if φ ( j ) = φ ( i ) = 1 \\ {\tilde{w}}_{i , j} ( t ) = - 1 + {η}_{2} ( 1 + {\tilde{w}}_{i , j} ( t - 1 ) ) & if φ ( i ) = 1 and φ ( j ) = 0 \\ 0 & otherwise\end{matrix} \qquad ( 2 )$$

η₂ and η are constants such that η₂>η. φ(i) and φ(j) take on the values of either 0 or 1.

Optionally, the weights between the neuron pair neurons i and j may alternatively be updated symmetrically. This is done for applications where the associative relationship between inputs is symmetrical. An example of such an application is where the data structure 150 is used for modeling associations between words; for a given word pair, the relationship between the two words is symmetrical. In this case, the second condition in Equation 2 is ignored in the computation and Equation 2.1 is carried out to modify the synaptic weight \tilde{w}_{j,i}(t).

\tilde{w}_{j,i}(t)=\tilde{w}_{j,i}(t−1)+η(1−\tilde{w}_{j,i}(t−1)) (2.1)

Referring again to the data set of FIG. 2g as an example, the data sample “PINE” has features {IsAPlant} and {CanGrow}. When this data samples is presented to the data structure, the neurons which fires will include the neuron of the module corresponding to {IsAPlant} which fires when the input is +1, and the neuron of the module corresponding to {CanGrow} which fires when the input is +1. In other words, presenting the example “PINE” will tend to increase the value of \tilde{w}_{i,j} such i indicates the neuron of the module corresponding to {IsAPlant} which fires when the input is +1, and the j indicates the neuron of the module corresponding to {CanGrow} which fires when the input is +1.

By performing step 230 for every data sample, neurons with a strong time-correlation will tend to get a high value of \tilde{w}_{i,j}, while data samples with weak similarities (e.g. the +1 neuron of the module corresponding to {HasLeaves} and the +1 neuron of the module corresponding to {HasLegs}) will have a value for \tilde{w}_{i,j}, which remains low.

It is noted that when step 230 is carried out, Hebbian associative learning results in synaptic weights \tilde{w}_{i,j} which are capable of characterizing relationships between related training data. As an example, in an ANN which is trained using training data containing the names of celebrity couples, a first neuron which shows a high response to the input data sample “Jennifer Aniston” tend to fire at the same time as a neuron which shows a high response to the input data sample “Brad Pitt”.

Hebbian associative learning step 230 is carried out once through the data set.

In step 240, a check is performed to determine if the condition for training termination is fulfilled. If the termination condition is not fulfilled, step 250 is carried out, to generate a new layer of module(s) and the steps 220 to 240 are then repeated to train the modules of that layer. If the termination condition is fulfilled, training is complete and the data structure 150 is ready for use. Thus, the number of layers (denoted L in FIG. 2i) in the data structure 150 is determined in the method of FIG. 2c using the termination condition. When the termination condition is fulfilled, no more layers are created above the layers which are in existence and the training of the data structure 150 terminates.

Examples of termination conditions are:
a.) terminate if L=v1, where v1 is an integer indicating the desired number of layers in the data structure 150; or
b.) terminate if when there are exactly v2 number of modules at the highest layer of the data structure 150, where v2 is an integer indicating the desired number of modules in the highest layer of the data structure 150 (e.g. V2=1).

In step 250, a new layer of the hierarchy is created, receiving inputs from what had previously been the top layer of the network the “next lower layer”) of the hierarchy. Unless all modules of the new layer receive inputs from all of the modules of the next lower layer, this requires that the modules of the next lower layer are grouped, such that all modules of a given group feed their outputs to the inputs of a single module of the new layer.

Given that the present layer in the hierarchy is a r-th layer, integration may be done randomly where the outputs of each module of the r-th layer is randomly allocated to be inputs for the modules of the (r+1)-th layer. Optionally, integration may instead be done in a manual fashion where outputs of two or more specific modules of the r-th layer are brought together to serve as inputs to the modules of the (r+1)-th layer. Further optionally, it is envisaged that integration may be done automatically using the method 2000 that is described later with the aid of FIG. 2f.

After step 250, the method returns to step 220, to generate the neurons of the new layer. Note that when step 220 is performed for the second and subsequent times, it generates a given module using neurons defined by respective weight vectors having a number of components equal to the number of neurons of the preceding layer which feed their outputs to that module. When sub-step 240 is performed for the second and subsequent times, w_{i,j} denotes the weight vector of the i-th neuron of the module and indicates the weight which that i-th neuron gives to the j-th neuron from the layer beneath.

The set of steps 220 to 250 are performed iteratively, generating a new layer each time the set of steps (loop) is carried out. At each layer of the data structure 150, the training of the modules of that layer comprises a competitive learning step 220. This is based on the function performed by a given module and described above i.e. a linear operation of multiplying neuron weight vectors with the inputs, followed by a non-linear operation performed on the results (e.g. a winner-takes-all operation).

In the case where step 220 is performed for iterations after the first iteration, the outputs from the modules created in the previous iteration (i.e. outputs from the previous layer of the hierarchy) are used as the input features.

When step 230 is performed in subsequent interactions it may be performed not only for pairs of neurons ij in the present layer (i.e. the layer being created in this loop of the algorithm) but also a neuron in the present layer and a neuron in any preceding layer. Thus. Hebbian learning allows for the recognition of associations between each neuron in different layers of the hierarchy.

We now turn to a more detailed description of how integration step 250 is performed. There are two possibilities:

1) Modules of each new layer are formed taking as their inputs the outputs of a randomly selected group of the modules of the next lower layer.
2) More sophisticated integration, e.g. by performing graph partitioning.

In the second possibility, the integration may be done by using an automatic grouping algorithm to group together neurons of the (r−1)-th layer, such that the outputs of the grouped neurons at the (r−1)-th layer are fed to one or more modules in the r-th layer. Referring to FIG. 2f. FIG. 2f shows a method 2000 for performing the integration step 250 automatically by performing graph partitioning to form groups of neurons. FIG. 2e then shows two groups of neurons G₁ and G₂ which formed by graph partitioning.

The method 2000 first groups the neurons of an r-th layer of the hierarchy into a plurality of groups denoted G_{P} for 1≦p≦P. There are thus P resultant groups.

For each of the P groups, the output of each neuron within the group serves as the input to a respective “parent” module in the next higher layer.

In step 2010, an adjacency matrix is provided containing the synaptic weights between every possible pair of neurons at the r-th layer. Such an adjacency matrix may be provided as the result of step 230. Recall that in step 230, Hebbian associative learning is performed upon the ANN for the layer in order to derive the co-occurrence frequency between associated neurons. Optionally, in the case where there are a large number of possible neuron pairs, a fraction of neuron pairs are randomly marked as “abandoned” (i.e. the synaptic weights are assumed to be zero and are not updated) in order to avoid a combinatorial explosion of the number of neurons and layers in the hierarchy. When a neuron is marked “abandoned”, the neuron is not considered in step 230 i.e. the adjacency matrix is provided without taking into account these “abandoned” neurons.

Graph partitioning is then used in the subsequent steps to find community structures of the neurons of the r-th layer. This is done using a hierarchical clustering approach which results in non-overlapping communities of neurons.

In step 2020, N is initialized to denote the set of all neurons in the ANN.

In step 2022, for each i-th neuron NᵢεN the sum of the strength of its connections with other neurons in the graph is computed as cᵢ using Equation 3.

$${c}_{i} = {\sum }_{j ∈ N , j \neq i}^{ } {\tilde{w}}_{i , j} \qquad ( 3 )$$

\tilde{w}_{i,j} denotes the synaptic (Hebbian) weight of the synaptic connection between the i-th neuron and j-th neuron and is obtained from the adjacency matrix provided in step 2010.

In step 2024, the neuron Nᵢ_{ₘₐₓ} with the maximum synaptic weight is found from amongst all neurons in N. This is done as shown in Equation 4

cᵢ_{ₘₐₓ}=max_{iεN}cᵢ (4)

In step 2026, using the results of step 2024, a p-th group (denoted by Gₚ) is formed containing only the neuron Nᵢ_{ₘₐₓ} i.e. Gₚ={Nᵢ_{ₘₐₓ} }.

In step 2028, the K number of neurons (denoted by {Nₐ₁, Nₐ₂, . . . N_{aK}}) that are strongly connected Nᵢ_{ₘₐₓ} to are added to Gₚ. In other words, the neurons {Nₐ₁, Nₐ₂, . . . N_{aK}} represent neurons with the K strongest connections with neurons existing in the present iteration of Gₚ. Then, let Gₚ=Gₚ∪{Nₐ₁, Nₐ₂, . . . N_{aK}}. Then, we seek the K neurons which are most strongly connected to Nₐ₁ and add those which are not already part of Gₚ to Gₚ. Then, we seek the K neurons which are most strongly connected to Nₐ₂ and add those which are not already part of Gₚ to Gₚ. And so on.

Step 2028 is iterated until the number of neurons in Gₚ, reaches a threshold value α.

In step 2030, the neurons that are in Gₚ are removed from N. Thus, N is updated to be N=N−Gₚ. Also, all synapses that are associated with neurons that are in Gₚ are removed. It is noted that while the term “removed” is used in this step, the neurons are not literally removed from the ANN that is constructed in the earlier steps 220 and 230. Rather, the neurons that are to be “removed” are flagged “unavailable” for the next iteration of steps 2022 to 2030.

The steps 2022 to 2030 are then iterated until when N={} When that happens, P groups of neurons are formed. For each group Gₚ where 1≦p≦P, the output of each group Gₚ serves as the input to a higher layer “parent” module. In step 2032, the output of each group G_{P} is connected an input of a higher layer “parent” module.

Step 220 is then repeated to form the next higher layer of the hierarchy.

### Method of Using the Data Structure

After training, the data structure 150 may be used using the method 2100 that is shown in FIG. 2h. The method 2100 is described next with reference to FIGS. 2h and 2i. FIG. 2i is a diagram showing the data structure 150 when it is being used.

In step 2110, features 2115 are Ted into the inputs of the modules of the lowest layer of the data structure 150. These modules are shown in FIG. 21 to be Modules 1,1 to 1,x.

In step 2120, the output(s) 2125 from the neurons of the highest layer of the data structure 150 are read. The highest layer of the data structure is shown in FIG. 2i to comprise Module L,1. Note that there are L layers in the hierarchy of the data structure 150.

In the case where the data structure 150 is used as an associative mechanism, the input features 2115 are representative of a first piece of information and the output(s) 2125 are representative of information associated with the first piece of information.

In the case where the data structure 150 is used as a data store, the input features 2115 are representative of a retrieval keyword. The output(s) 2125 then are representative of the stored data that is associated with the retrieval keyword.

In the case where the data structure 150 is used to perform dimension reduction, the features 2115 represent a piece of higher dimension information. The output(s) 2125 is of a lower dimension than in the features 2115 and represents a form of the features 2115 with reduced dimensions.

Optionally, in step 2130, the output(s) 2135 of the associated neurons at the intermediate layers (i.e. layers between the lowest and highest layers) are read. Like the output(s) 2125, these output(s) 2135 are produced in response to the features 2115 that are fed in step 2110. The output(s) 2135 are more weakly associated with the features 2115 than the output(s) 2125.

### Example A

### An Example of the Method for Training the Data Structure

The method 200 for training the data structure is now further described in an example. In this example, the data samples that are shown in the matrix of FIG. 2g are used as the “raw” training data that is provided in step 210. This data may be read from a storage device.

In step 212, the “raw” training data is parsed in a column-wise fashion in order to arrange them into a vector representation. Each data sample of the “raw” training data is characterized by a vector with 28 elements, each element indicating a property. Examples of these properties are {IsAPlant} which is indicative that the source object from which a data sample is obtained is a plant, and {CanFly} which is indicative that the source object from which the data sample is obtained can fly. In a vector representation of a data sample, each properly is represented as a Boolean element in the vector; for an element corresponding to a property, a value of “1” indicates that the data sample is characterized by the property, while a value of “0” indicates that the data sample is not characterized by the property.

Note that while the elements of the data that is used in this example are Boolean, it is envisaged that in other applications of the invention the data structure may use data elements which are integers, real or complex number types, or vectors with multiple components each of which is an integer, real number or complex number. Optionally, the data may contain multiple types of elements (e.g. some may be integers and some may be vectors such that every component is a real number).

In step 214, segmentation is then performed on the vectorized representation. After segmentation, the 1st feature segment (which contains the 1st element of each of the feature vectors i.e. the {IsAPlant} property) has the following values in successive data samples:

[1. 1. 1. 1. 1. 1. 1. 1. 0. 0. 0. 0. 0. 0. 0. 0. 0. 0. 0. 0. 0.]

The 9th feature segment which contains the 9th element of each of the feature vectors i.e. the {IsWhite} property has the following values in successive data samples:

[0. 0. 0. 1. 0. 0. 1. 0. 0. 0. 0. 1. 0. 0. 0. 1. 0. 0. 0. 0. 0.]

It is noted that whilst each element of the feature vectors is modeled using one module in the present example, it is also possible that each element of the feature vectors may be modeled using more than one module. Such a model may thus more plausibly mimic biology.

The steps 220 to 250 are then carried out iteratively in a hierarchical fashion. In each instance of the step 220, is a growth threshold value of τ=0.2 is used.

i. Training Iteration 1

At the lowest layer of the hierarchy (i.e. Layer 1), the feature vectors resulting from step 214 are used as the input features for step 220. Competitive learning is performed to cluster the input features into 28 data clusters (which are also referred to as modules), each of which is represented by one or more neurons. An ANN with 54 neurons is produced from step 220. It is noted that since each element of each feature vector is a one dimensional Boolean value, the neurons used accordingly are also one dimensional and binary. When the algorithm was performed, it was noted that the 54 neurons were produced, distributed between the 28 modules such that with the exception of two modules (which have one neuron each), the other 26 modules each have two neurons—one neuron that is excitatory (with a value of 1), and another that is inhibitory (with a value of 0).

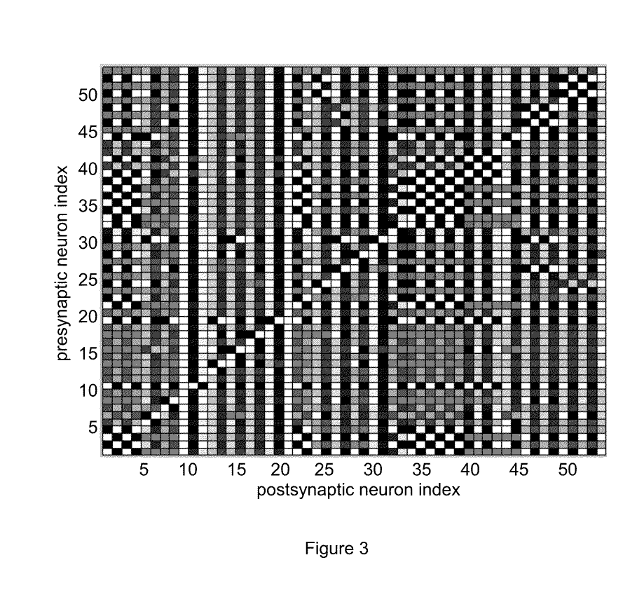

In step 230, Hebbian associative learning is carried out on the ANN resulting from step 220. FIG. 3 shows the synaptic weights of the connections between each pair of the 54 neurons after the completion of the first iteration of step 230. Grids that are coloured white indicate a stronger synaptic weight while grids which are darker have a lower synaptic weight. In step 240, it is determined that the termination condition for training is not fulfilled and thus step 250 is performed. In step 250, the ANN generated in Layer 1 is then integrated into the subsequent layer of the hierarchy (i.e. Layer 2) by mapping the output of 2 children modules from the ANN of Layer 1 to an input of a parent module of Layer 2. In other words, a 2:1 integration ratio is used. Accordingly, Layer 2 has 14 modules. The termination condition is not fulfilled in step 240 and so step 250 is performed (using the first possibility for implementing step 250: the random method), and a second iteration of the steps 220 to 240 is performed.

ii. Training Iteration 2

At the next layer of the hierarchy (i.e. Layer 2), competitive learning is performed again in step 220 to cluster the outputs from the 54 neurons of the ANN of Layer 1 into 14 modules. A layer with 38 neurons is produced from step 220.

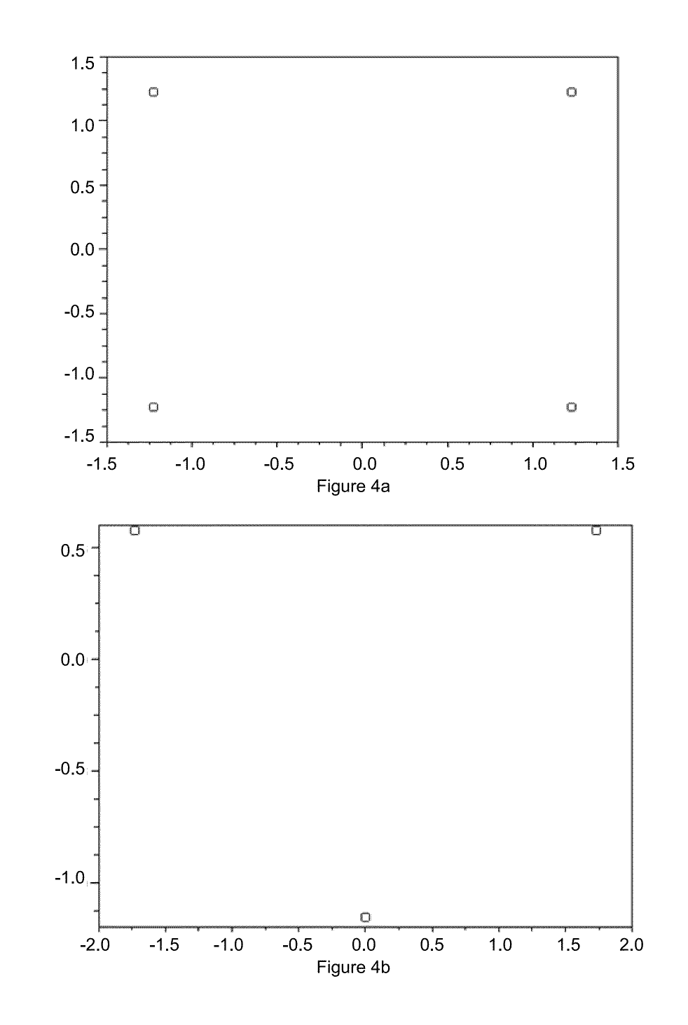

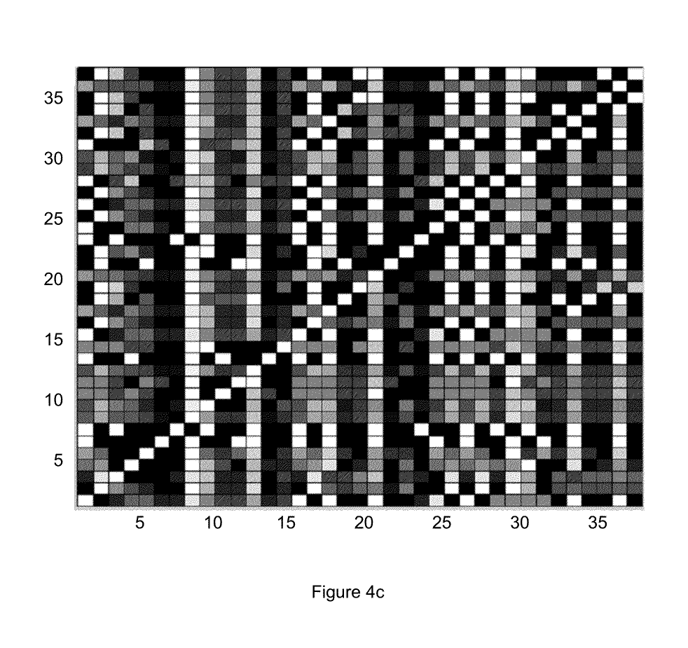

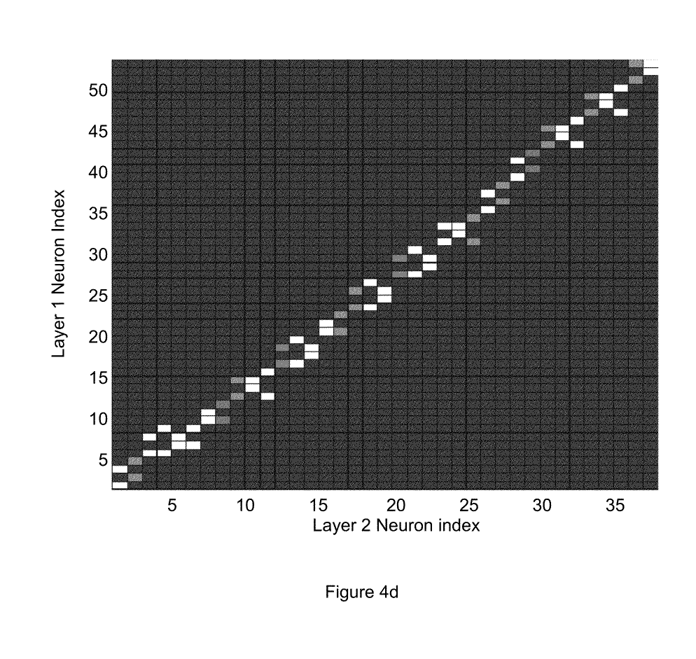

The neural configuration of the neurons in the modules after step 220 is shown in FIGS. 4a and 4b. FIG. 4a shows the two-dimensional principal components for a module that is indexed 2, while FIG. 4b shows the two-dimensional principal components for modules that are indexed 4, 5, 7, 8, 9, 12, 13 and 14. It can be seen that the module that is indexed 2 has 4 neurons (corresponding to the 4 principal components). Also, the modules that are indexed 4, 5, 7, 8, 9, 12, 13 and 14 each have 3 neurons (corresponding to the 3 principal components).

In step 230, Hebbian associative learning is carried out on the ANN produced from step 220. FIG. 4c show the synaptic weights of the connections between each pair of the 38 neurons after the completion of the second iteration of step 230. FIG. 4d then show the sparse connection weights i.e. the association between the 54 neurons of the ANN of Layer 1 and the 38 neurons of Layer 2.

In step 240, it is determined that the termination condition for training is not fulfilled and thus step 250 is performed.

iii. Training Iteration 3

In step 250, the outputs of the neuron in Layer 2 are grouped to form the inputs of modules in the next higher layer of the hierarchy (i.e. Layer 3) by mapping the output of 2 children modules from the ANN of Layer 2 to an input of a parent module of Layer 3. Accordingly, Layer 3 has 7 modules. A third iteration of the steps 220 to 240 is performed. Competitive learning is once again performed in step 220 to cluster the outputs from the 38 neurons of the ANN of Layer 2 using the 7 modules. A layer with 33 neurons is produced from step 220. In step 230, Hebbian associative learning is carried out on the ANN produced from step 220.

In step 240, it is once again determined that the termination condition for training is not yet fulfilled and thus step 250 is performed.

iv. Training Iteration 4

In step 250, the layer generated in Layer 3 is then integrated into the next higher layer of the hierarchy (i.e. Layer 4) by mapping the output of 2 children modules from Layer 3 to respective inputs of all the parent modules of Layer 4 but one. For the last parent module of Layer 4, 3 children modules from the ANN of Layer 3 are mapped to it. Thus, Layer 4 has 3 modules. Competitive learning is performed in step 220 to cluster the outputs from the 33 neurons of Layer 3 using the 3 modules of Layer 4. An ANN with 30 neurons is produced in step 220.

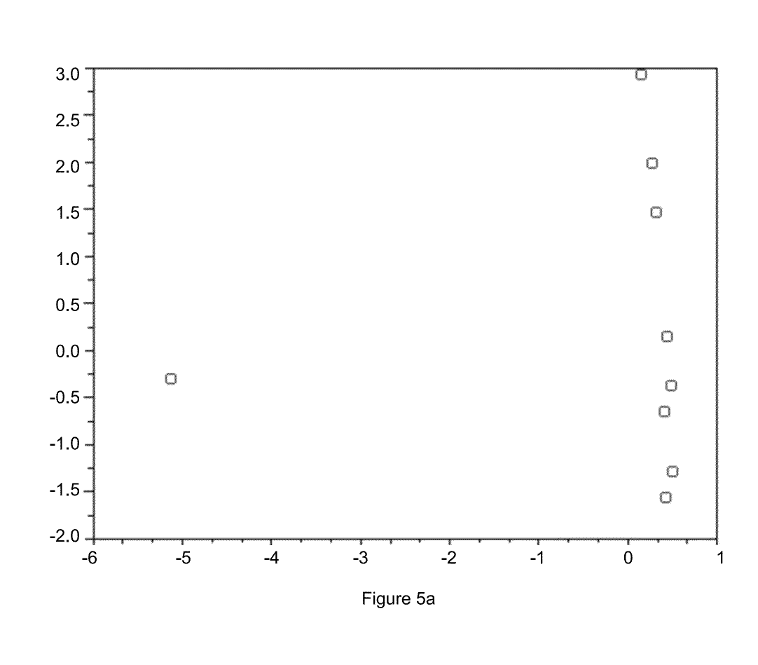

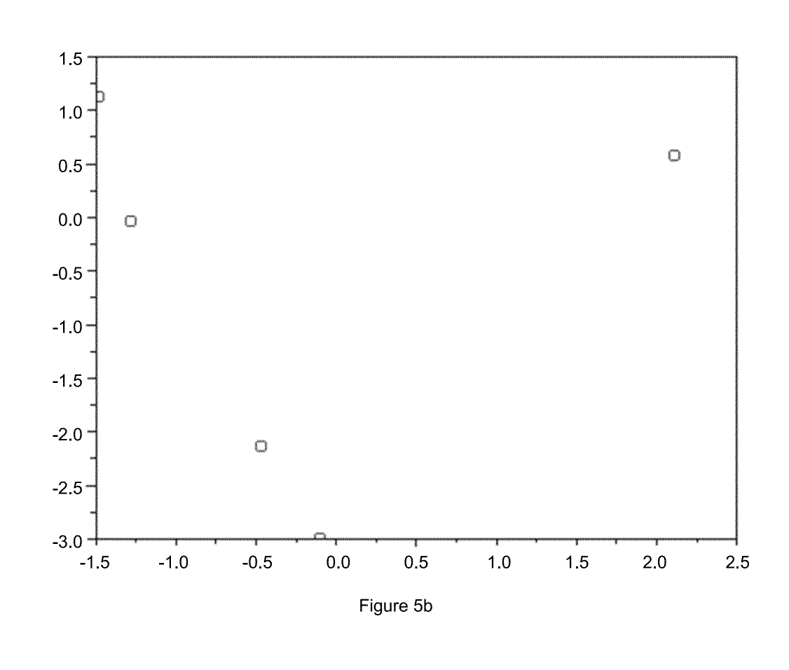

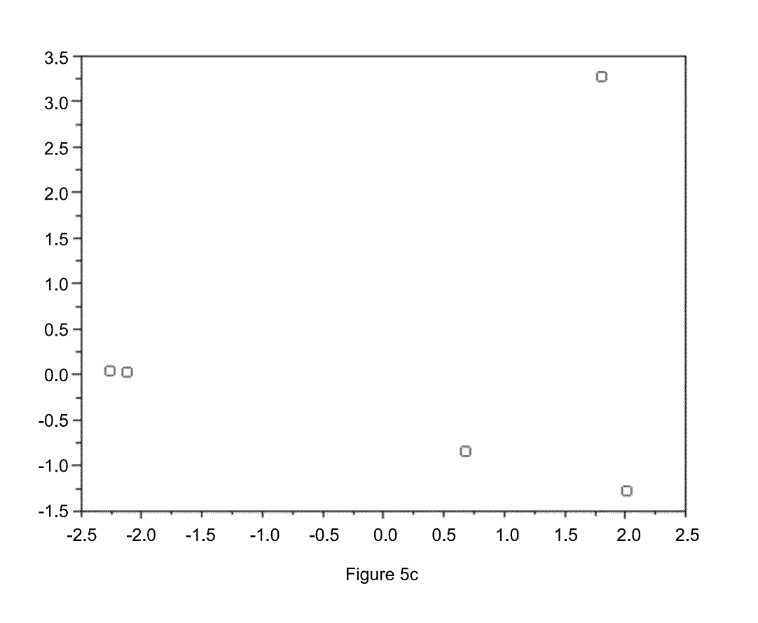

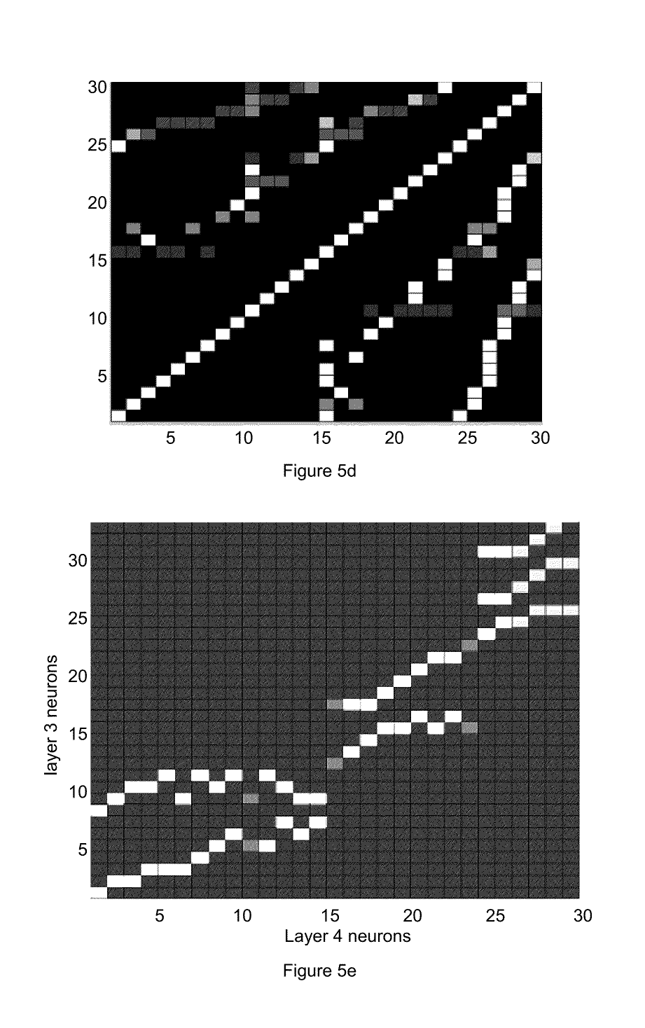

FIGS. 5a, 5b and 5c show the two-dimensional principle components for respective modules that are indexed 1, 2 and 3. It can be seen that the modules respectively have 9, 5 and 5 neurons.

In step 230, Hebbian associative learning is carried out on the ANN produced from step 220. FIG. 5d show the synaptic weights of the connections between each pair of the 30 neurons after the completion of the fourth iteration of step 230. FIG. 5e then show the sparse connection weights between the 33 neurons of the ANN of Layer 3 and the 30 neurons of the ANN of Layer 4.

In step 240, it is once again determined that the termination condition for training is not yet fulfilled and step 250 is performed.

v. Training Iteration 5

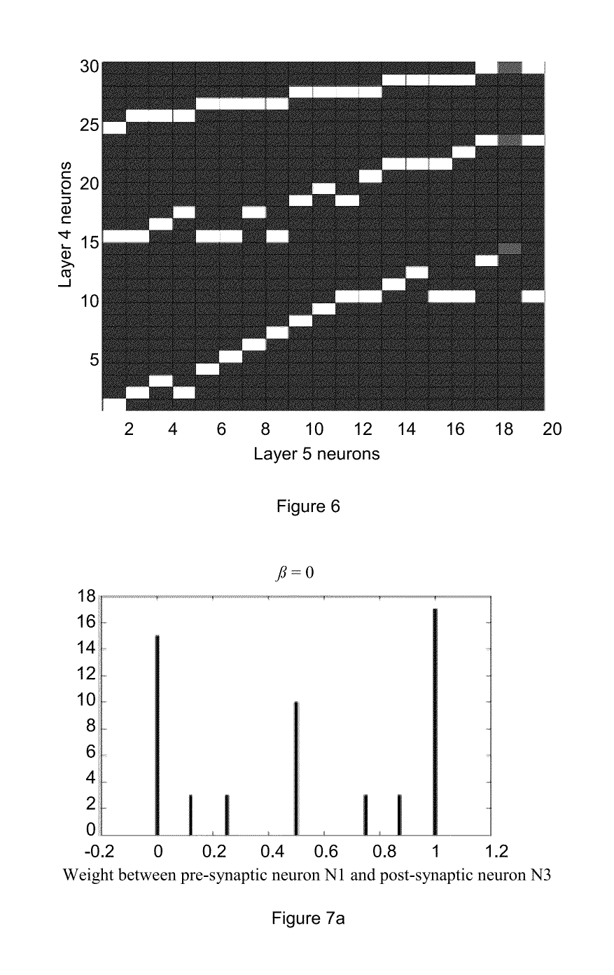

In step 250, the ANN generated in Layer 4 is integrated into the next higher layer of the hierarchy (i.e. Layer 5) by mapping the output of the 3 modules of Layer 4 to the input of a single module in Layer 5. in other words, Layer 5 only has one module. Competitive learning is performed in step 220 to cluster the outputs from the 30 neurons of the ANN of Layer 4 into a single module. An ANN with 20 neurons is produced from step 220. In step 230, Hebbian associative learning is carried out on the ANN produced from step 220. In step 240, it is determined that the termination condition for training is now fulfilled. Training thus terminates and the resultant data structure is ready for use. The sparse connection weights between the 30 neurons of the ANN of Layer 4 and the 20 neurons of the ANN of Layer 5 are shown in FIG. 6.

Properties of the Data Structure after Training

Upon the completion of training, the data structure 150 has a hierarchical associative memory structure. The data structure 150 has the properties of:
i. being capable of performing feature association;
ii. being capable of obtaining gist and topics;
iii. having a weighted influence of features to categories, thus exhibiting a similarity with semantic dementia; and
iv. having multiple representations.

In connection with the property iv., by having multiple representations, the output of each neuron at the highest layer has a plurality of input features mapped to it at the lowest layer. Thus, each output at the highest layer has multiple representations. Such a property accordingly allows the data structure 150 to perform dimensionality reduction or feature summarization.

The properties i. to iii. are described in greater detail below.

i. Feature Association

Using the data structure trained in Example A, by evaluating the ANN of the lowest layer the data structure 150, the property of feature association may be observed. FIG. 3 shows the synaptic strengths between all possible pairs of the neurons at the lowest layer. There are 54 neurons i.e. there is one neuron for each element in the feature vectors used in training.

The index for the pre-synaptic neurons and post-synaptic neurons respectively are indicated in the y and x axes. Feature association may be demonstrated by observing the synaptic strength between the neuron with index 26 (indicating the property {CanFly}) and the neuron with index 48 (indicating the property {HasFeathers}). The synapse connecting the neuron with index 26 to the neuron with index 48 has a synaptic strength of 1.0 i.e. in other words, the data structure is trained to associate that everything which flies will have feathers. However, the synapse connecting the neurons in the reverse direction (i.e. the synapse connecting the neuron with index 48 to the neuron with index 26) has a synaptic strength of 0.75. The synaptic weights between two neurons thus may not be symmetric.

It is noted in Tversky (1977), “Features of similarity”, Psycholgical review, 84, 327-352 that the similarity between two stimuli should not be represented by the distance between both stimuli. Tveresky (1977) suggested that this is because such a metric may not satisfy the asymmetric properties of semantic information, and may violate the triangle inequality. Tveresky (1977) thus concluded that conceptual stimuli are best represented in semantic memory by a set of features.

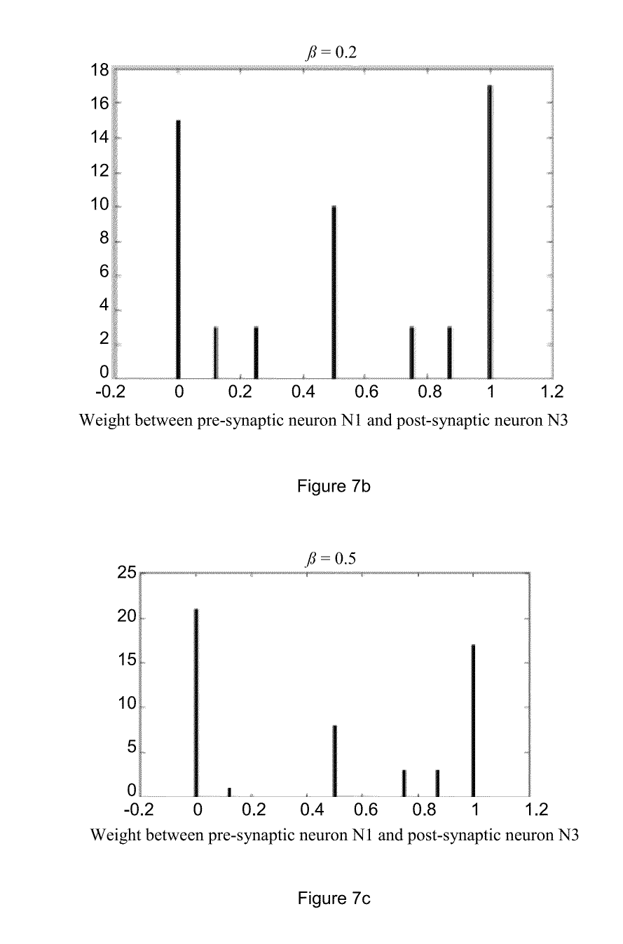

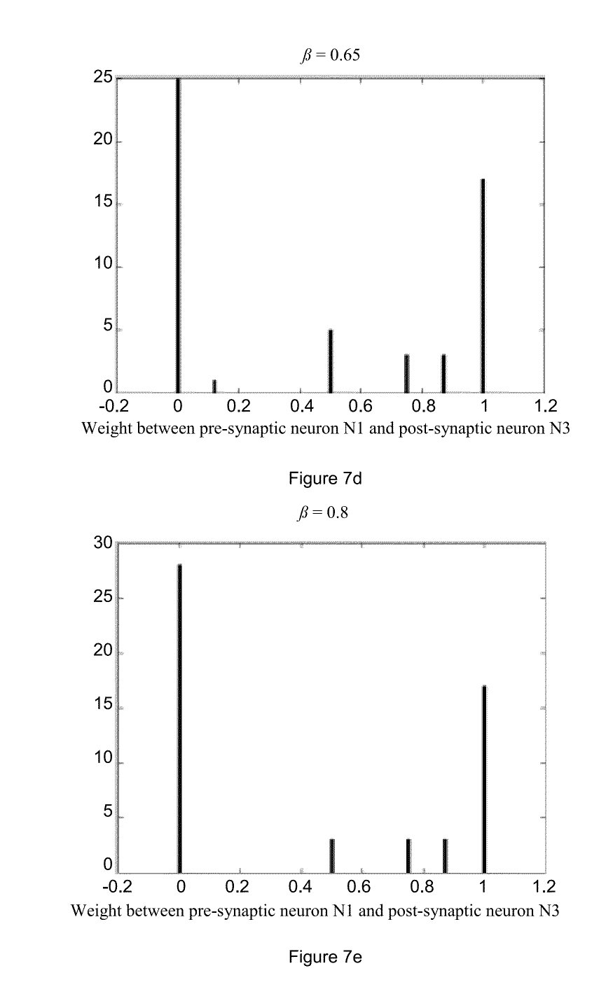

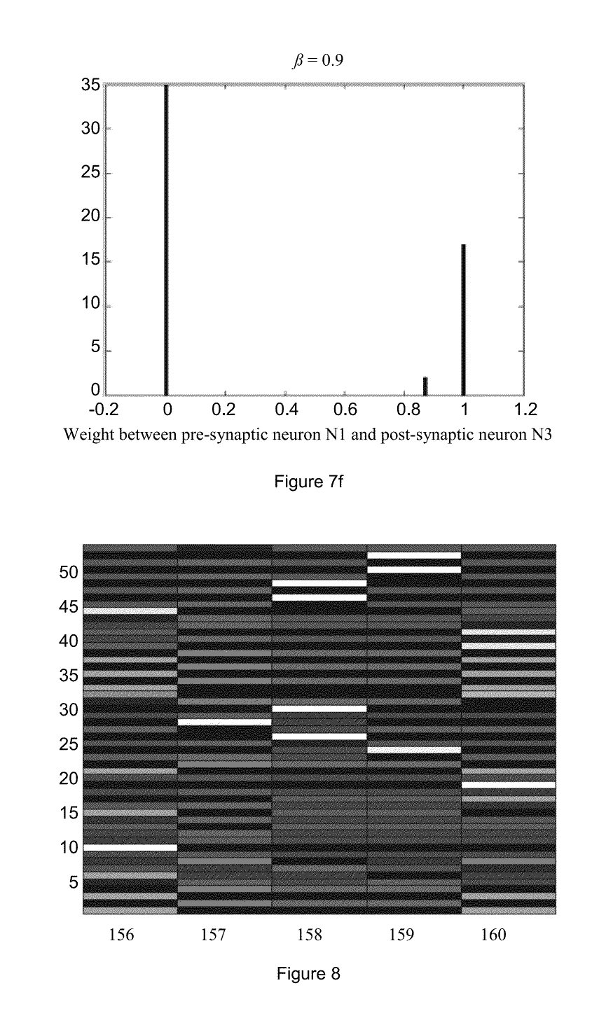

Since the synaptic weights between two neurons of Example A may not be symmetric, the data structure of Example A thus demonstrates the asymmetric properties of semantic information. This is shown in FIGS. 7a-7f which respectively show for threshold (denoted by β) values 0, 0.2, 0.5, 0.65, 0.8 and 0.9, histograms showing the distribution of the synaptic weights w(N1, N3) between pair of selected neurons (denoted N1 and N3) of the lowest layer of the hierarchy. Note that N1 is connected to N3 by way of an intermediate neuron N2 using Hebb's rule; N1 thus is the pre-synaptic neuron while N3 is the post-synaptic neuron. β is used as the cut-off for selecting the neurons N1 and N3; only neurons pairs where w(N1, N2)>β and w(N2, N3)>β for an intermediate neuron N2 are selected to be in the respective histograms. It can be seen from the FIGS. 7a-7f that for all values of β, there exists cases where N1 and N3 are not directly connected (i.e. where w(N1, N3)=0) in spite of the weights w(N1, N2) and w(N2, N3) being greater than β.

It can be seen that regardless of how highly connected the neurons N1 and N2 are, or of how highly connected the neurons N2 and N3 are, there exists cases where N1 and N3 are not connected. This thus shows that the data structure of Example A demonstrates triangle inequality.

ii. Obtaining Gist and Topics

Once the data structure is created in the method of FIG. 2c, labels may be assigned to some or all of the neurons. Some or all of the labeled neurons are in the second and higher layers. By assigning labels to the neurons, each neuron becomes associated with an identity and the outputs of each neuron thus acquire a meaning by way of the associated identity.

Labels may be assigned to the neurons using either a statistical method, or a measure of goodness method. The statistical method is disclosed in Honkela, T., Kaski, S., Lagus, K., & Kohonen, T. (1997). “WEBSOM—self-organizing maps of document collections”. Proceedings of WSOM (Vol. 97, pp. 4-6) and Lagus, K., Honkela, T., Kaski. S., & Kohonen, T. (1996). “Self-organizing maps of document collections: A new approach to interactive exploration.” Proceedings of the second international conference on knowledge discovery and data mining (pp. 238-243). The contents of these documents are incorporated herein by reference. The measure of goodness method is disclosed in Lagus, K., Kaski, S., & Kohonen, T. (2004). “Mining massive document collections by the WEBSOM method”. Information Sciences, 163(1-3), 135-156, the contents of which is also incorporated herein by reference.

In the statistical method of label assignment, for a given term, the means and standard deviations for the term-dimension is computed over all the neurons of the data structure to respectively yield a global mean and a global standard deviation. The “term-dimension” here refers to the input to the module. For a given neuron, the “mean” for a given term-dimension denotes the average inputs to the neuron of those data samples which cause the neuron to fire. The “standard deviation” for a given term-dimension denotes the standard deviation of the inputs to the neuron of those data samples which cause the neuron to fire. The means for the term-dimension are computed over the neurons of each module. Each term-dimension for each module is then assigned a score based on the number of standard deviations the mean of the term-dimension is from the global mean. This is expressed as a ratio to the global standard deviation of the term-dimension. The global mean of a term-dimension thus represents how often the term should occur in a typical sample population, while the global standard deviation of a term-dimension represents the amount of variation that is to be expected within a subset of the entire data space. Thus, if the mean of the term-dimension of a module is a large number of standard deviations away from the global mean, the term-dimension of this module is considered to be more prominent when compared to the term-dimension of another module that is of a smaller number of standard deviations away from the global mean. The term-dimension that is more prominent is a better module descriptor or label.

In the measure of goodness method of label assignment, a goodness function of a term T with respect to a j-th module is computed using Equation 5.

G(T/j)=Fⱼ^{clust}(T)×Fⱼ^{coll} (5)

Fⱼ^{clust}(T) is a parameter that is indicative of the relative importance of the term T in the clustering of the j-th module.

$${F}_{j}^{clust} ( T ) = \frac{{f}_{j} ( T )}{\sum {f}_{j}} \qquad ( 6 )$$

fⱼ(T) is a count of the number of times the term T occurs in the j-th module.
Σfⱼ is a summation of the number of times in which all terms occur in the j-th module.

Fⱼ^{coll}(T) is a parameter which function as an inhibitory factor for diluting the influence of words that are predominant in other clusters. It is obtained using Equation 7.

$${F}_{j}^{coil} ( T ) = \frac{{F}_{j}^{clust} ( T )}{{\sum }_{i} {F}_{i} ( T )} \qquad ( 7 )$$

The intersection of the candidate labels determined by the two methods (i.e. the statistical method, or the measure of goodness method) is used to heuristically determine the confidence of a neuron. In other words, the higher is the number of overlapping terms found by the two methods, the more strongly associated is the neuron with the term.

Referring once again to the data structure of Example A, depending on the growth threshold value used for training at each of the layers, the topics corresponding to any given set of features is obtained from the highest layer of the data structure. Using the synaptic connections between the ANN of consecutive layers of the hierarchy, input features are input into the data structure by triggering a neuron at Layer 1 of the data structure and associations may be made with a topic when a neuron at Layer 5 of the data structure shows a response. It is noted that a smaller threshold value for r when used for training gives a larger number of topics and a larger threshold value for τ gives a smaller number of topics.

FIG. 8 shows the probability that an input feature associated with a property (represented along the y-axis) triggers a neuron that is associated with a topic (represented along the x-axis). The columns of FIG. 8 correspond to the top 5 neurons in the data structure trained in an alternative embodiment to Example A i.e. the 156^{th} to 160^{th} neuron respectively. The rows of FIG. 8 correspond to the 28 properties i.e. 28 Boolean input features, each represented using 2 input neurons at the lowest layer. These probability values are obtained by integrating the synaptic weights along the synaptic pathways from the neuron associated with the input features, to the neuron that is associated with the topics. FIG. 8 thus shows the association between the 28 properties of the input feature vectors (at the lowest layer of the data structure) and 5 topics (at the highest layer of the data structure) in the data structure trained in the alternative embodiment. The properties are grouped into topics as follow:

| | |
|---|---|
| Topic 1. | plant living green grow roots bark branches |
| Topic 2. | animal living grow move walk skin legs fur |
| Topic 3. | animal living grow move fly wings |
| Topic 4. | animal living grow move swim scales gills |
| Topic 5. | plant big living grow leaves roots bark branches |

The bottom-up hierarchical structure of the data structure creates a non-uniform distributed representation the feature inputs. This thus represents a difference from the Parallel Distributed Processing (PDP) model of semantic cognition where the distribution of feature inputs is governed by the network architecture. The network architecture in the PDP model is user specified. Once training is complete, the PDP model exhibits a feed-forward structure.

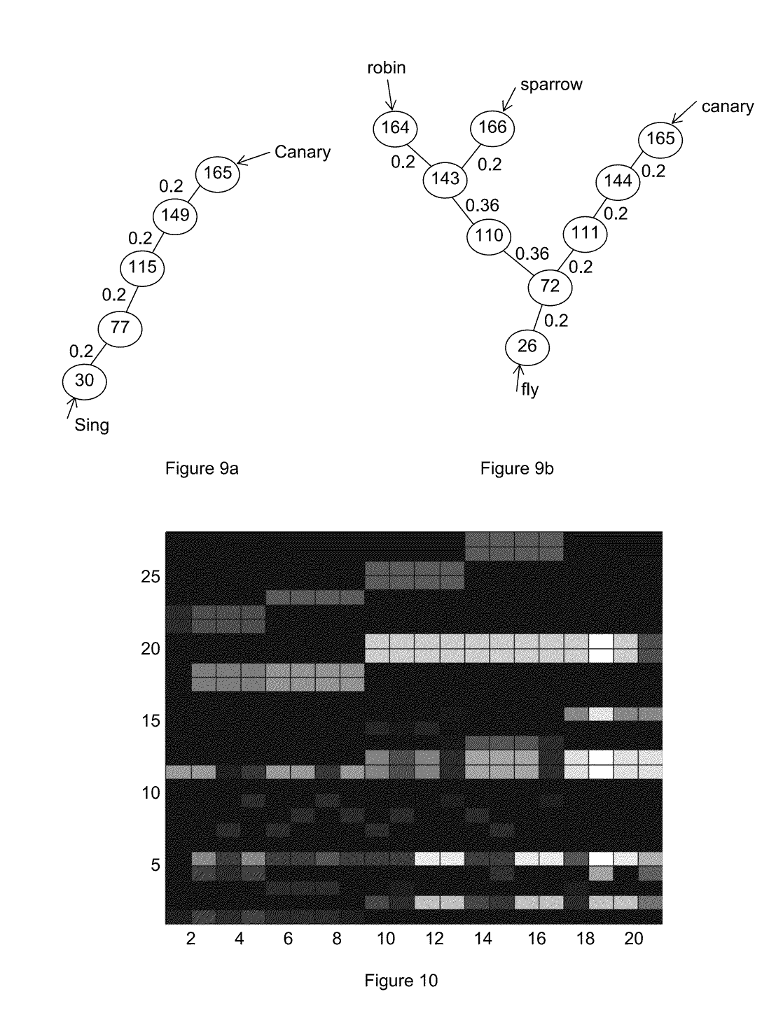

Reference is now made to FIGS. 9a and 9b. FIG. 9a shows an example of a synaptic pathway in the data structure of Example A associating the property {CanSing} with a topic which has been given the label “canary”. FIG. 9b shows another example of a synaptic pathway in the data structure of Example A associating the property {CanFly} with the topics “robin”, “sparrow” and “canary”. The data structure of Example A thus is capable of obtaining gist and topics associated with the properties of input features.

Notably, the synaptic pathways of the data structure (for example as shown in FIGS. 9a and 9b for a top layer with 20 neurons) may change depending on the features used. Further, it is noted that the distribution of the representation increases with the generality of the features.

iii. Similarity with Semantic Dementia

It is observed in Rogers T T and McClelland J L (2003), “The parallel distributed processing approach to semantic cognition”, Nature Reviews Neuroscience, 4(4), pp 310-322 that the PDP model of semantic cognition exhibits properties that can be observed in patients with semantic dementia. Specifically, patients with semantic dementia lose knowledge of domain constrained features before they lose knowledge of domain general features.

Referring back to Example A, the data structure training in that example is repeated using a small growth threshold value τ so that more neurons are added to each module, and thus allowing all possible data samples in the training data to be represented. By setting a small threshold value r for training, unique representations are obtained at the top layer of the data structure for 20 of the 21 data samples in the training data.

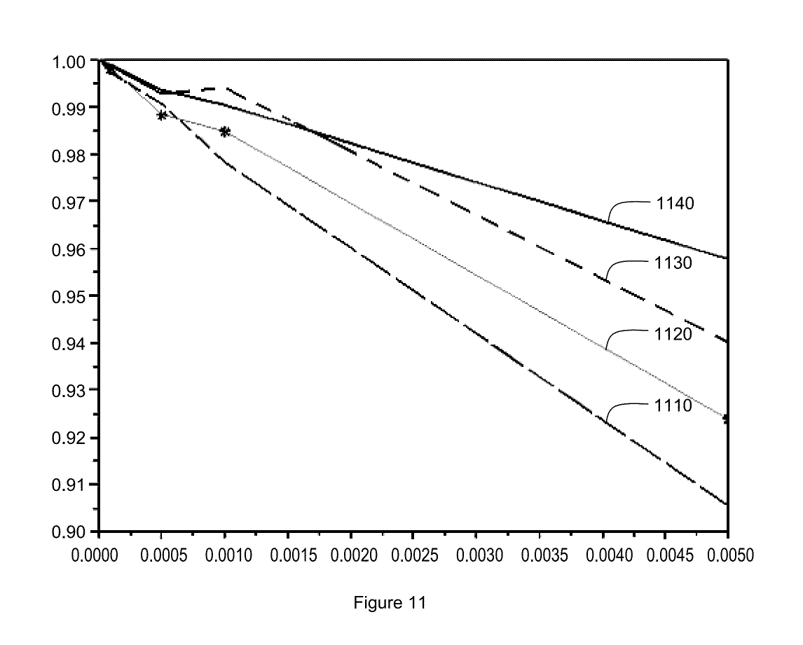

FIG. 10 show the synaptic weights associating properties and topics across the hierarchy. Referring then to FIG. 11, the activation of the concepts {Canary, CanSing} (indicated by line 1110), {Canary, CanFly} (indicated by line 1120), {Canary, IsAnimal}, (indicated by line 1130) and {canary, CanGrow} (indicated by line 1140) are shown. Semantic dementia is simulated by applying Gaussian noise to the weights of the neurons. The trend of information loss is observed to be similar to that of semantic dementia, i.e. specific properties e.g. {CanSing} are lost earlier than that of more general properties {CanGrow}. In other words, the data structure exhibits a weighted influence of features to categories. Thus, it would appear that domain specific properties of the encoded concepts are lost before the general properties. Accordingly, the data structure appears to exhibit a similar information decay property as the PDP model of semantic cognition.

### Using the Data Structure to Perform Text-Based Information Retrieval

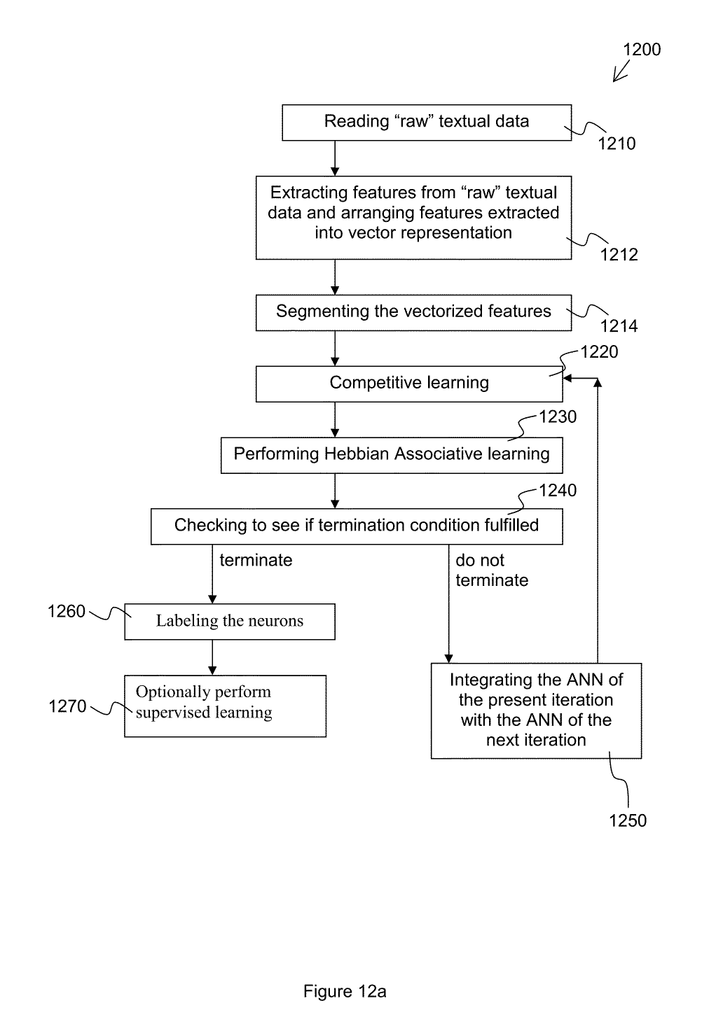

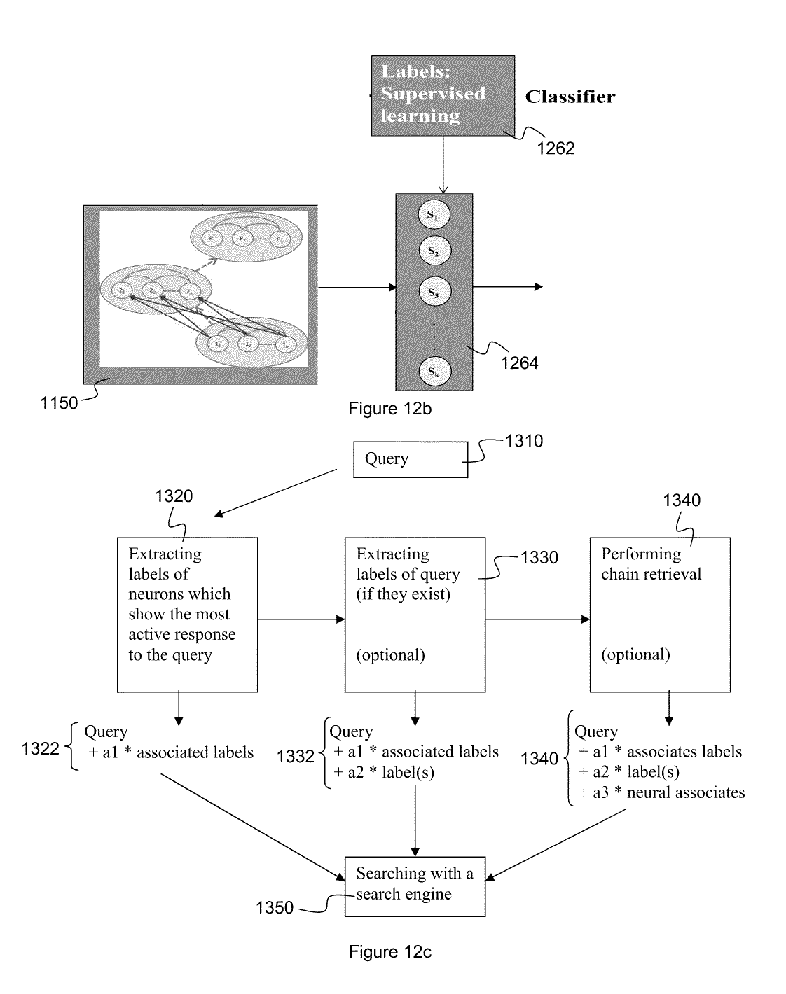

It is envisaged that in a specific variation of the method 200, a data structure 1150 may be trained using the method 1200 of FIG. 12a for use in text-based information retrieval. Steps of the method 1200 which are similar to the steps of the method 200 are denoted by the reference numeral of the steps of the method 200 with the addition of 1000.

In step 1210, an input device reads “raw” textual data in the form of a plurality of text documents from a storage device.

In step 1212, feature extraction is performed on the “raw” textual data. First, the textual data is parsed and tokenized into a plurality of words using text delimiters such as whitespaces and punctuation marks. Then, a collection of td-idf weights are built according to the occurrence frequency of terms in the plurality of words. The collection of td-idf weights is then formed into a feature vector where each element in the vector is indicative of the occurrence frequency of a term. It is noted that a single feature vector is formed for each text document read in step 1210; there is thus a plurality of feature vectors resulting from step 1212.

In step 1214, segmentation is performed on the plurality of feature vectors resulting from step 1212. This step produces a plurality of feature segments. Each feature segment is associated with the occurrence frequency of a term.

The steps 1220 to 1250 are then performed iteratively to build a data structure in a bottom-up hierarchical fashion until when a termination condition is fulfilled. When the termination condition is fulfilled, the data structure 1150 is obtained.

Collectively, the steps 1220 to 1250 perform unsupervised learning to yield the data structure 1150.

For each iteration, in step 1220, competitive learning is performed to cluster the input features into a predetermined number of module. This produces an ANN for the iteration. In step 1230, Hebbian Associative learning is performed upon the ANN resulting from step 1220, to generate a matrix of synaptic weights. In step 1240, a check is performed to determine if the condition for training termination is fulfilled. The termination condition used may be similar to that used in step 240 of the method 200. If the termination condition is not fulfilled, step 1250 is carried out and the ANN of the present iteration is integrated with the ANN of the next iteration.

If the termination condition is deemed fulfilled in step 1240, training is complete and the data structure 1150 is ready for use in performing text-based information retrieval.

Also, the neurons of the data structure 1150 are labeled after training in a post-processing step 1270.

Notably, the method 1200 differs from the method 200 in that an (optional) step 1270 there is a supervised learning based on the output of the data structure as defined above. FIG. 12b shows an arrangement which can do this. It includes an additional classifier 1262 (such as a human), generating ground truth classifications). if present, the classifier 1260 may be used to label some or all of the data samples which were used to train the data structure 1150. The labels may take any of k values. The labeled data is used in a supervised learning algorithm in which a one-layer network 1264 is generated.

The network 1264 has k neurons shown as S₁, . . . , Sₖ. Its inputs are the outputs of the top layer module of the data structure 1150 generated in steps 1210 to 1240, and these inputs are fed to each of the k neurons of the network 1264.

The network 1262 has one neuron for each possible respective value of the label generated by the classifier. Each of the k neurons generates an output using a respective weight vector. The output of the network 1264 is the label value corresponding to the neuron which gives the highest output. The network 1264 is taught using the supervised learning algorithm to output labels equal to the labels generated by the classifier 1250.

Turning to FIG. 12c, FIG. 12c shows a method 1300 of performing text-based information retrieval using the data structure 1150 that is trained using the method 1200. Associative retrieval is performed on the data structure 1150 so as to obtain a plurality of query terms which may be submitted to a search engine 1350. The search engine 1350 then returns search results associated with the submitted query terms.

In step 1310, a query is provided. The query is then fed as the input at the lowest layer of the data structure 1150 in the form of an associated feature. As an example, the query may be the word “diamond”, which is one of the features associated with respective modules of the input layer of the data structure 1150. In this case, a value of “1” is fed into the input module which is labeled “diamond”, and a value of “0” is fed to all the others.

In step 1320, the labels of the neurons which show the most active responses to the query are extracted. This is done by sorting the neurons of the intermediate layers (i.e. layers between the lowest and the highest layers) of the data structure 1150 into an order based on the activity. A pre-determined number Y number of highest neurons may be identified. Their associated labels are extracted. The query is then augmented with the extracted associated labels to form the result 1322. The method may then pass to step 1350 of inserting the query and the extracted associated labels into the search engine.

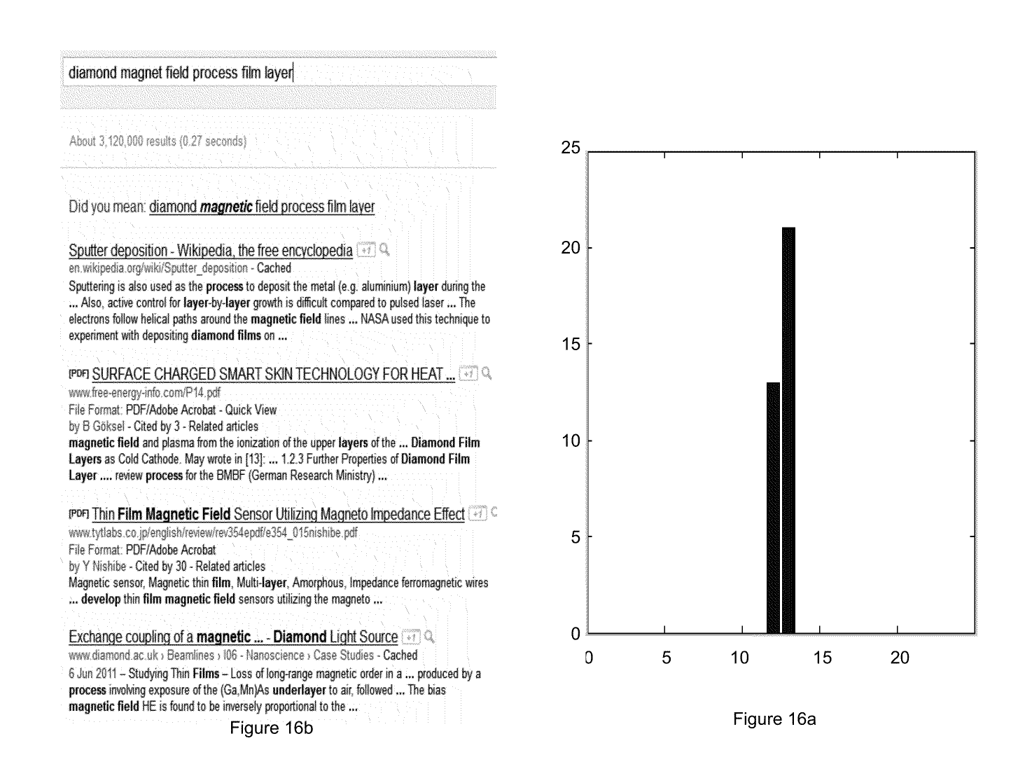

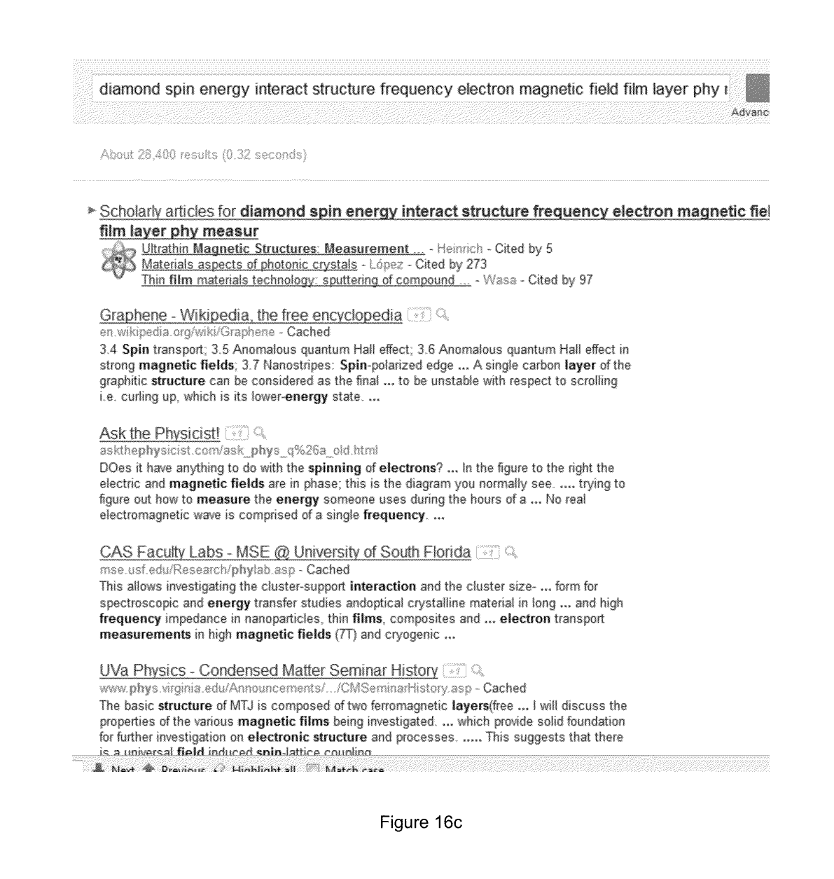

Taking the example of the case where the query is “diamond”, the extracted associated labels may be “magnet”, “field”, “process”, “film” and “layer”. FIG. 16a shows the neural activation (y-axis) over the top Y=20 neurons (x-axis) of the data structure 1150. It is noted that two neurons i.e. the 12^{th} and 13^{th} indexed neuron have non-zero activation values. Since each neuron may be labeled with more than one term, multiple associated labels are obtained, in this case 4 associated labels from the two neurons. The result 1322 when fed to the search engine 1350 gives a search result that is shown in FIG. 16b. FIG. 16b shows the search results from the Google search engine when the search is conducted using the query and the extracted associated labels.

Optionally, the extracted associated labels may be weighted by a factor a1 to give them a greater or lesser search importance.

In optional step 1330, the output of the top layer of the data structure 1150 is fed into the neural network 1264. The neural network 1264 generates a further one or more labels. The result 1322 is augmented with the extracted label(s) (if any) to form the result 1332. The result 1332 of step 1330 comprises of the query (from step 1310), the extracted associated labels (obtained in step 1320), and the extracted label(s) (obtained in step 1320). Taking the example of the case where the query is “diamond”, the extracted labels may be “spin”, “energy”, “interact”, “structure”, “frequency” and “electron”. In this case, the result 1332 when fed to the search engine 1350 gives a search result that is shown in FIG. 16c. FIG. 16c shows the search results from the Google search engine when the search is conducted using the query, the extracted associated labels and the extracted label.

Optionally, the extracted label may be weighted by a factor a2 to give it greater or lesser search importance. Note that a1 and a2 are not used in the example of FIG. 16c.

In optional step 1340, chain retrieval is performed. This means that using one or more of the active neurons identified 1320, the method uses the synaptic weight table obtained by the Hebbian learning to identify one or more other neurons in the data structure 1150 which are connected to the active neuron(s) by a high synaptic weight, or by a chain of pairwise high synaptic weight connections. These neurons are referred to as “neural associates”. The labels of the neural associated are then obtained. The result 1352 from step 1330 is augmented with the labels of the neural associates to form the result 1342.

The result 1342 thus comprises the query (from step 1310), the extracted associated labels (obtained in step 1320), the extracted label(s) (obtained in step 1330) and the labels of the neural associates (obtained in step 1340). Optionally, the labels of the neural associates may be weighted by a factor a3 to give it greater or lesser search importance.

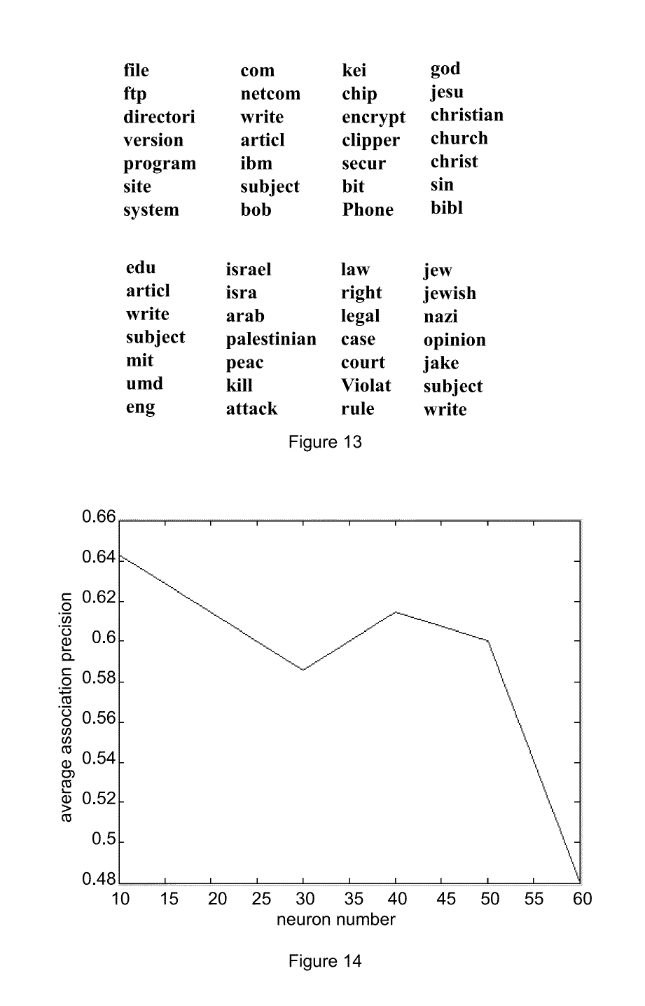

Next, experimental results are presented for the associative retrieval of terms from a data structure 1150 that is trained with a dataset (“corpus”) containing 20 items of newsgroup text using the method 1200. FIG. 13 show the labels of the top 8 neurons obtained by training the other data structure 1152 with the 20 newsgroup text corpus. This figure shows the associative properties of the data structure 1152. Terms that belong to the same topics or gist are associated with each other. As an example, using “file” as the query, the method 1300 of text-based information retrieval when performed upon the data structure 1152 yields “ftp” “directori”, “version”, “program”, “site” and “system” as associated labels in step 1320.

FIG. 14 shows the average association precision of the neurons for the 20 newsgroups corpus. The x-axis represents the number of neurons in the data structure 1150. The average association precision is obtained by averaging the association precision of the top k neurons. The association precision is evaluated against a set of ground-truth results. It is seen that as the number of neurons increases, the association precision decreases.

Further, results are presented for the associative retrieval of terms from yet another data structure 1150 when the data structure 1150 is trained with a scientific document corpus using the method 1200. The scientific document corpus comprises a set of 1375 documents obtained from various conferences.

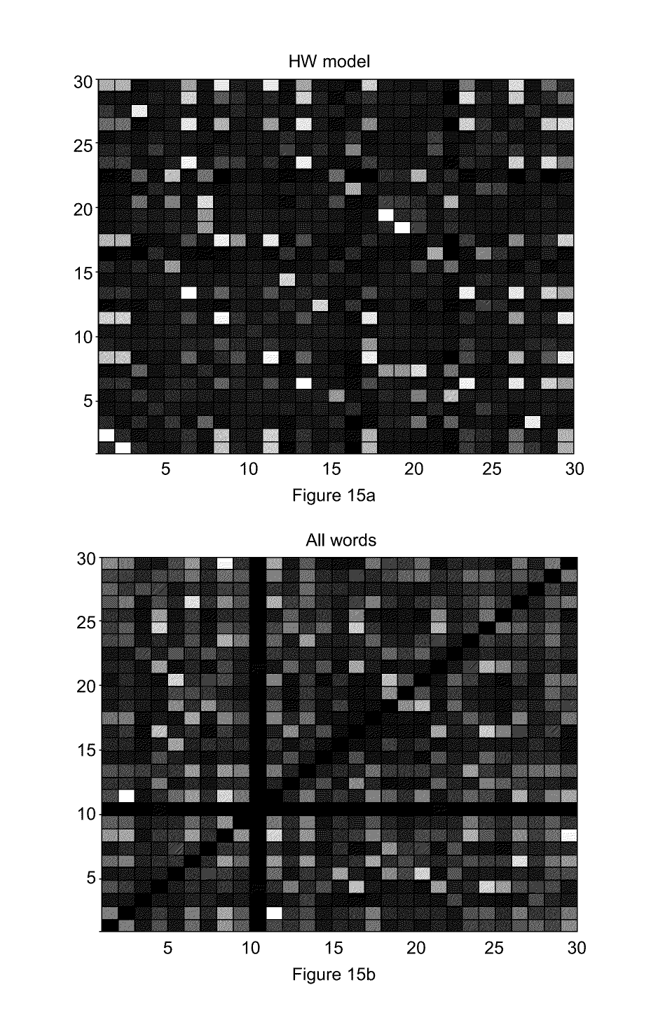

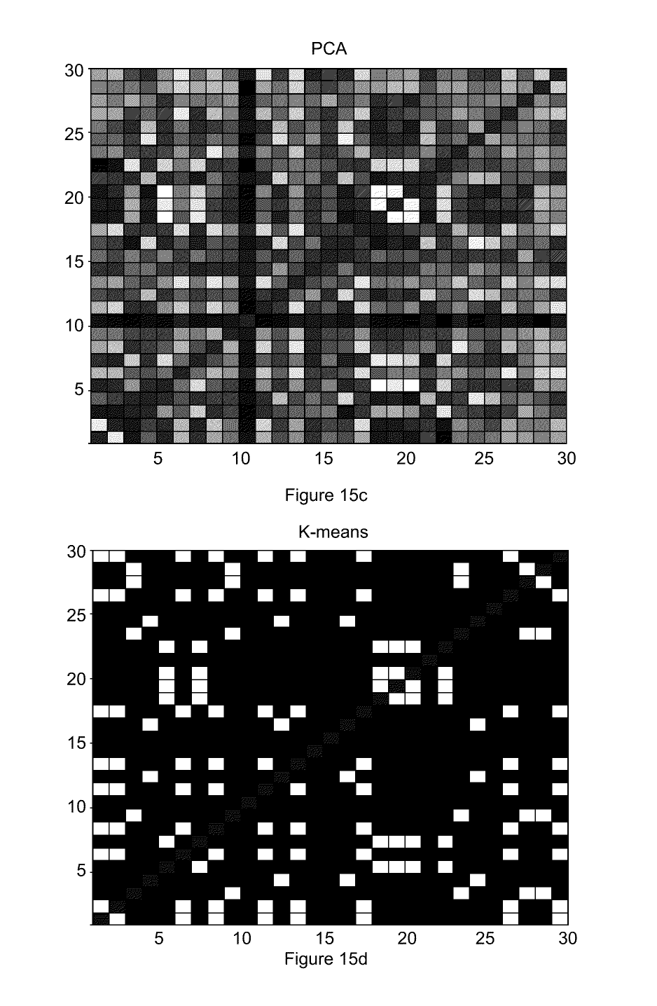

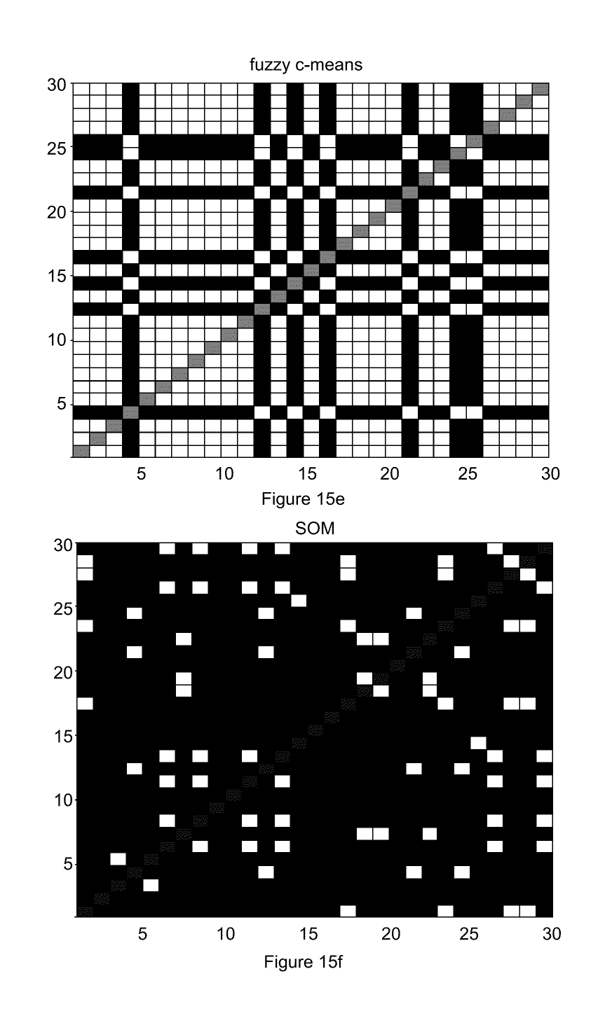

FIG. 15a-15f shows the correlation coefficients of 30 randomly selected documents when used to perform dimensionality reduction. FIG. 15a shows the correlation coefficients when a data structure trained using the method 1200 (i.e. the “HW model”) is used, FIG. 15b shows the correlation coefficients when all the words of each document are used in computing the correlation, FIG. 15c, shows the correlation coefficients when Principal Component Analysis (PCA) is used to perform dimensionality reduction, FIG. 15d shows the correlation coefficients when the K-means algorithm is used to perform dimensionality reduction, FIG. 15e shows the correlation coefficients when a Fuzzy-c means based algorithm is used to perform dimensionality reduction, and FIG. 15f shows the correlation coefficients when a Self-Organizing Map (SOM) is used to perform dimensionality reduction.

Referring specifically to FIG. 15a, it is seen that the “HW model” is capable of performing dimensionality reduction as the correlation coefficients are characterized by having a high coefficient value (indicated by a bright spot in the grid) for certain word pairs. Thus, by using all 30 documents as the input to the data structure 1154, the 30 documents are summarized (or have the dimensionality of their feature space reduced) to the words which are the labels of neurons corresponding to bright spots in the grid.

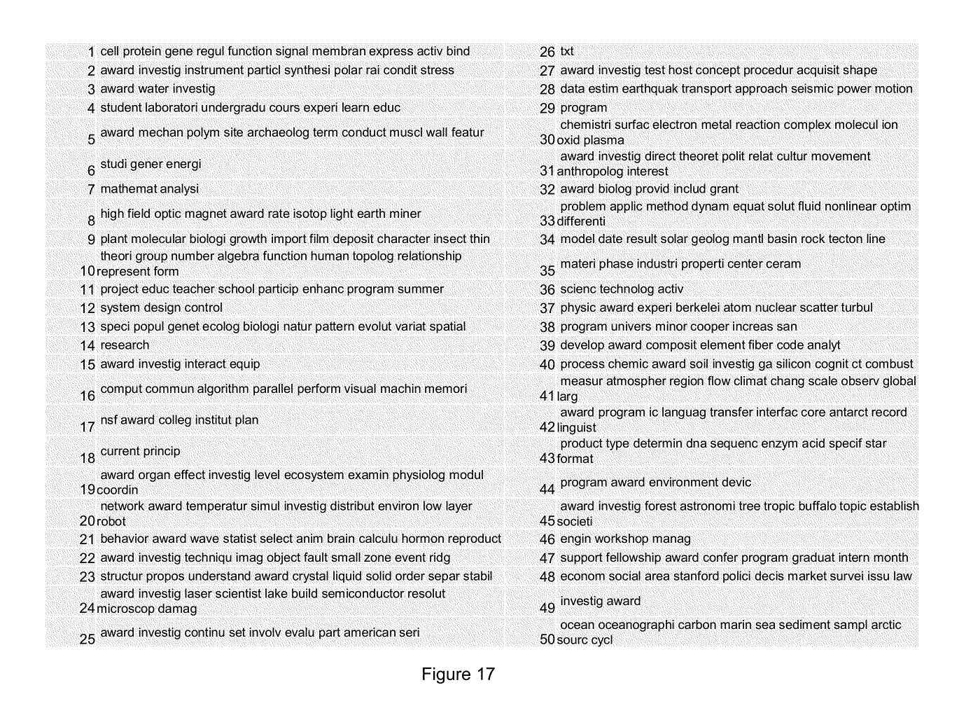

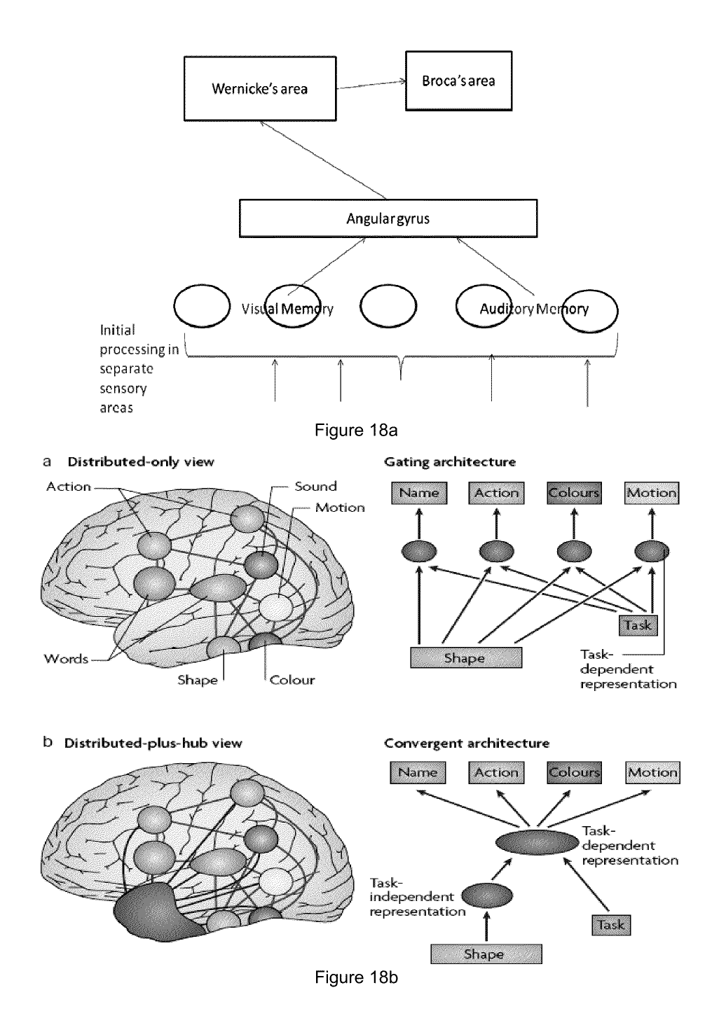

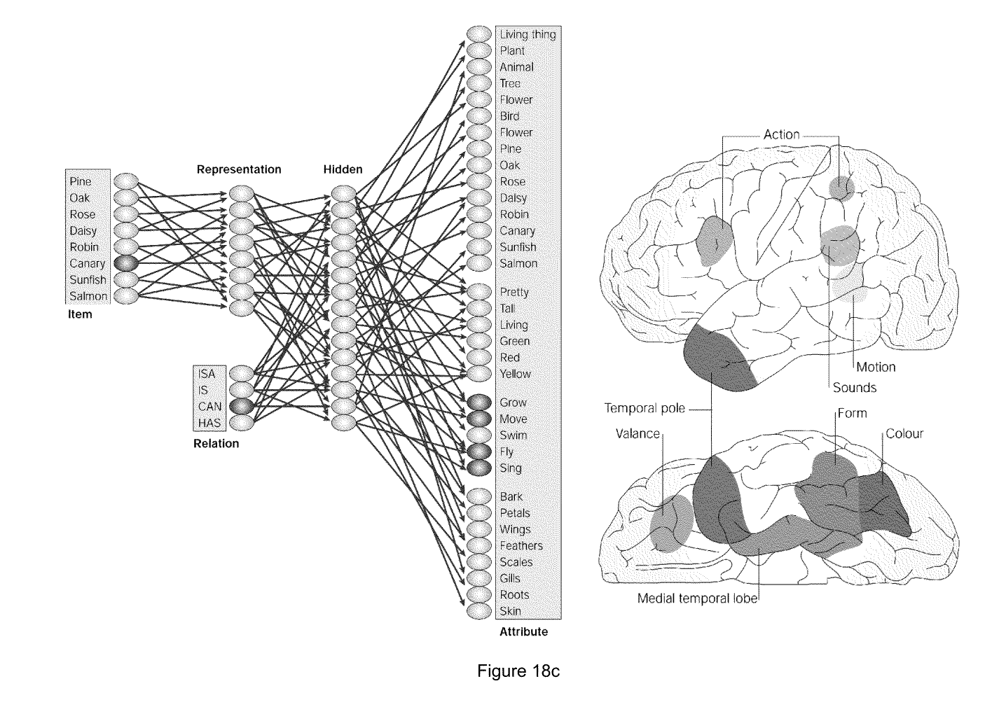

A further data structure 1150 is next trained on the NSF research awards database using the method 1200. FIG. 17 shows the labels of the top 50 neurons of the further data structure 1156. The labels of these top 50 neurons represent the top 50 topics of documents that are present in the database.

Whilst example embodiments of the invention have been described in detail, many variations are possible within the scope of the invention as will be clear to a skilled reader.

1. A method for generating a data structure comprising a plurality of layers (r=1, . . . , L) ordered from a lowest layer (r=1) to a highest layer (r=L), each layer including one or more modules, the modules being ordered in a bottom-up hierarchy from the lowest layer to the highest layer, each of the plurality of modules being defined by one or more neurons configured to produce output signals in response to one or more inputs to the module, the method employing a plurality of training data samples, each data sample being a set of feature values;
the method comprising:
(i) generating a lowest layer (r=1), wherein, for each module of the first layer, one or more neurons of the module are generated associated with one or more respective data clusters in the respective feature value, and
(ii) generating one or more higher layers of the data structure (r=2, . . . L) by, for the r-th higher layer, generating modules of the r-th layer which receive as inputs the output signals of a corresponding group of neurons of the (r−1)-th layer, and performing competitive clustering, whereby, for each module of the r-th layer, one or more neurons of the module are generated associated with a respective data cluster in the inputs to the module; and
(iii) performing a Hebbian algorithm to obtain, for each of a plurality of pairs of the neurons, a corresponding plurality of synaptic weights, each synaptic weight being indicative of the correlation between the output signals of the corresponding pair of neurons.

2. The method for training a data structure according to claim 1 wherein step (i) comprises generating a lowest layer (r=1) by, for a sequence of said data samples, transmitting the feature values to respective ones of the modules, and performing competitive clustering.

3. The method for training a data structure according to claim 1 wherein the modules are ordered in the bottom-up hierarchy in a tree-like fashion.

4. The method for training a data structure according to claim 1 wherein step (ii) comprises forming said groups of neurons of the (r−1)-th layer based on the synaptic weights between neurons of the (r−1)-th layer.

5. A method according to claim 4 in which said groups are formed by:
(a) generating a group of neurons by:
identifying a first neuron from the plurality of modules of the (r−1)-th layer, the first connected neuron having high total synaptic weights with other neurons of the (r−1)-th lower layer, and
adding to the group of neurons other neurons connected to the first neuron by a high synaptic weight;
(b) repeating step (a) at least once, each time generating a new group of the neurons of the (r−1)-th layer which have not previously been assigned to a group.

6. The method of claim 5, wherein a number of neurons in each group limited by a threshold value.

7. The method of claim 1 wherein in step (iii) the Hebbian learning algorithm is performed by successively presenting the data samples, determining pairs of the neurons which react to the data sample, and updating a synaptic weight corresponding to the pair of neurons.

8. The method of claim 7 in which the synaptic weights are updated by a linear function of their previous value.

9. The method of claim 1 wherein in step (iii) the Hebbian learning algorithm is performed for pairs of neurons in the same layer, and pairs of neurons in different layers.

10. The method of claim 1 wherein in step (ii) the competitive clustering is performed, upon presenting one of the data samples to the data structure, by adding another neuron to a given module when:
∀NᵢεN,∥X−Nᵢ∥>τ
where
N is the set of existing one neurons in the module.
X is the corresponding feature value of the one data sample, and
τ is a threshold value.

11. The method of claim 1, further comprising a step of generating the plurality of data samples by:
using a sensor to obtain an electronic signal;
quantizing the electronic signal into a plurality of features: and
segmenting the plurality of features into a plurality of feature vectors.

12. The method of claim 1, wherein the plurality of features is selected from the group consisting of:
a plurality of Gabor filtered features;
a plurality of Bags of words; and
a plurality of visual words.

13. The method of claim 1, wherein the competitive clustering is selected from the group consisting of:
using a self organizing map; and
using a self growing network.

14. The method of claim 1, further comprising labeling neurons of the second and higher layers of the data structure using the synaptic weights.

15. The method of claim 14, further comprising using the synaptic weights to form sets of the modules, and generating topics from the labels associated with the sets of modules.

16. The method of claim 1, further comprising a step of generating a neural network by supervised learning, the additional neural network receiving as inputs the outputs of the data structure, and the supervised learning teaching the neural network, upon receiving the outputs of the data structure generated from a data sample, to generate corresponding labels allocated to the data sample.

17. A method of associating text with a keyword using a data structure, the method comprising:
(a) generating a plurality of training data samples, which for each of a predetermined set of words, are indicative of the presence of the words in a respective plurality of text documents;
(b) generating a data structure comprising a plurality of layers (r=1, . . . , L) ordered from a lowest layer (r=1) to a highest layer (r=L), each layer including one or more modules, the modules being ordered in a bottom-up hierarchy from the lowest layer to the highest layer, each of the plurality of modules being defined by one or more neurons configured to produce output signals in response to one or more inputs to the module;
said generation being performed by:
(i) generating a lowest layer (r=1) by, for a sequence of said data samples, wherein, for each module of the first layer, one or more neurons of the module are generated associated with one or more respective data clusters in the respective feature value, and
(ii) generating one or more higher layers of the data structure (r=2, . . . L) by, for the r-th higher layer, generating modules of the r-th layer which receive as inputs the output signals of a corresponding group of neurons of the (r−1)-th layer, and performing competitive clustering, whereby, for each module of the r-th layer, one or more neurons of the module are generated associated with a respective data cluster in the inputs to the nodule;
(c) receiving a keyword;
(d) applying an input signal to the lowest layer of the data structure, the one of the one of more input signals being associated with the keyword; and
(e) using the data structure to generate the associated text.

18. The method of claim 17 in which in step (e) the associated text is generated by:
identifying neurons of the data structure which react strongly to the input signal; and
obtaining labels associated with the identified neurons.

19. The method of claim 18 further including:
performing a Hebbian algorithm to obtain, for each of a plurality of pairs of the neurons, a corresponding plurality of synaptic weights, each synaptic weight being indicative of the correlation between the output signals of the corresponding pair of neurons; and
in which step (e) further includes obtaining the labels associated with neurons connected to the identified neurons by strong synaptic weights.

20. The method of claim 17 in which step (e) further includes generating associated text by passing the output of a module of the highest layer of the data structure to a neural network which has been trained to generate labels by a supervised learning algorithm.

21. The method of claim 17 further comprising:
constructing a query string using the associated text; and
retrieving text from a database using the constructed query string.

22. An apparatus for generating a data structure comprising a plurality of layers (r=1, . . . , L) ordered from a lowest layer (r=1) to a highest layer (r=L), each layer including one or more modules, the modules being ordered in a bottom-up hierarchy from the lowest layer to the highest layer, each of the plurality of modules being defined by one or more neurons configured to produce output signals in response to one or more inputs to the module, the apparatus comprising
an input device configured to provide a plurality of training data samples; and
a processor;
a data storage device containing: a plurality of training data samples, each data sample being a set of feature values, and software operative, when implemented by the processor, to:
(i) generate a lowest layer (r=1) of the data structure, wherein, for each module of the first layer, one or more neurons of the module are generated associated with one or more respective data clusters in the respective feature value, and
(ii) generate one or more higher layers of the data structure (r=2, . . . L) by, for the r-th higher layer, generating modules of the r-th layer which receive as inputs the output signals of a corresponding group of neurons of the (r−1)-th layer, and performing competitive clustering, whereby, for each module of the r-th layer, one or more neurons of the module are generated associated with a respective data cluster in the inputs to the module; and
(iii) perform a Hebbian algorithm to obtain, for each of a plurality of pairs of the neurons, a corresponding plurality of synaptic weights, each synaptic weight being indicative of the correlation between the output signals of the corresponding pair of neurons.
